(19) United States
(12) Patent Application Publication
(10) Pub. No.: US 2016/0378050 A1
(43) Pub. Date: Dec. 29, 2016

(54) DRIVE TRANSMISSION MECHANISM AND IMAGE FORMING APPARATUS INCLUDING DRIVE TRANSMISSION MECHANISM

(71) Applicant: CANON KABUSHIKI KAISHA, Tokyo (JP)

(72) Inventors: Shinji Yamamoto, Kawasaki-shi (JP); Katsunori Yokoyama, Suntou-gun (JP); Kazuaki Takahata, Kawasaki-shi (JP); Rie Endo, Yokohama-shi (JP); Kazumasa Shibata, Kawasaki-shi (JP); Hiroki Kasama, Kashiwa-shi (JP)

(21) Appl. No.: 15/189,008

(22) Filed: Jun. 22, 2016

(30) Foreign Application Priority Data
Jun. 23, 2015 (JP) 2015-125239

(51) Int. Cl. G03G 15/00

(52) U.S. Cl. CPC G03G 15/757; F16H 1/20; F16F 15/04

(57) ABSTRACT

Included is a fixation portion having one end joined with a flat plate, and the other end fixed to a support plate that supports at least a part of a drive transmission portion including a drive transmission member that transits driving force caused in a drive source, and a length in a longitudinal direction and a length in a short direction are set such that a first vibration frequency vibrating in the longitudinal direction of the flat plate and a second vibration frequency vibrating in the short direction of the flat plate respectively resonate with mutually different vibration frequencies caused in the support plate around a portion where the fixation portion and the flat plate are joined.

### BACKGROUND OF THE INVENTION

Field of the Invention

The present invention relates to a drive transmission mechanism provided in an image forming apparatus such as a copying machine, a printer, or a facsimile device.

Description of the Related Art

In recent years, various business machines such as computers, facsimile devices, and copying machines have been widely spread. In association with that, the business machines installed in offices are required to be more silent to build a comfortable office environment.

For example, causes of noises generated from an image forming apparatus such as a copying machine vary. For example, examples of the noises caused by conveyance of recording materials include a noise of when a recording material loaded on a sheet tray is picked up and a noise generated when the recording material is conveyed with conveying rollers.

Further, in a case where a cooling fan is provided inside the image forming apparatus, a wind noise of the cooling fan can be one of the causes.

Further, examples of noises generated from a drive system of the image forming apparatus include drive sounds of motors, sounds generated from speed reducers for reducing and converting rotational speeds of the motors into predetermined rotational speed, and sounds generated from an apparatus frame to which the motors and the speed reducers are attached.

Among the noises, a ratio occupied by the noises generated from the apparatus frame is especially large. The noises caused by the apparatus frame generate vibration radiation sounds as the surface of the apparatus frame vibrates due to electromagnetic vibration of the motors attached to the apparatus frame or periodical excitation of the apparatus frame by the sped reducers.

Especially, in the image forming apparatus, the motors are rotated at a fixed speed. Therefore, noises of a frequency caused by rotation of the motors and gears are often generated. Especially, the vibration radiation sounds due to an order component of a rotational frequency of the motors and mesh frequency components of the gears are noticeable. Especially, a plurality of frequency peaks often contributes to the noises.

As a technology to decrease a vibration noise of one frequency peak, a dynamic vibration absorber exists. The dynamic vibration absorber adds a structure body that serves as a subsystem to a structure body that configures amain system. Accordingly, the dynamic vibration absorber transfers a vibration phenomenon of the main system into the subsystem at a certain frequency, thereby to suppress the vibration noises of the main system.

For example, in Japanese Patent Laid-Open No. 2010-032011, the dynamic vibration absorber is used to decrease the vibration noises of the image forming apparatus. The dynamic vibration absorber is provided to a certain frequency, of frequencies excited in an arbitrary place of the structure body where the vibration of the image forming apparatus becomes a problem, thereby to easily change a specific frequency.

Further, Japanese Patent Laid-Open No. 2009-257463 presents a configuration to absorb two or more vibration frequencies with one dynamic vibration absorber. A frame-like component in which dimensions of long sides and short sides are defined is fixed to end portions of radially extending arm portions, and supports the arm portions in a doubly supported beam state, thereby to absorb two vibration frequencies.

However, in Japanese Patent Laid-Open No. 2010-032011, although the frequency, vibration of which is absorbed by the dynamic vibration absorber, can be changed, one dynamic vibration absorber can support only one frequency. The image forming apparatus needs to absorb a plurality of vibration frequencies, and thus needs to have a large number of dynamic vibration absorbers having different specifications.

Further, Japanese Patent Laid-Open No. 2009-257463 has a configuration to absorb two vibration frequencies by one dynamic vibration absorber having four fixation portions. The radially extending arm portions need to have high rigidity so as not to shake.

The radial arm portions and a ring-like attenuating member (dynamic vibration absorber) are configured from separate components. Therefore, at least two components are necessary. Further, in a case where the arm portions and the dynamic vibration absorber are configured from separate components, variation is caused and deviation of vibration frequencies to be absorbed easily occurs when the components are fixed. Further, end portions of the sides of the ring-like attenuating member are fixed through four arm portions, and thus there is a problem that vibration motion of the attenuating member is restricted, and the degree of freedom of the two vibration frequencies is restricted.

### SUMMARY OF THE INVENTION

It is desirable to provide a drive transmission mechanism and an image forming apparatus including a drive transmission mechanism that can decrease vibration of a plurality of vibration frequencies with a simple configuration.

An object of the present invention is to provide a drive transmission mechanism including: a drive source; a drive transmission portion including a drive transmission member that transmits driving force caused in the drive source; a support plate which supports at least a part of the drive transmission portion; a flat plate; and a fixation portion having one end joined with the flat plate and the other end fixed to the support plate, wherein a length in a longitudinal direction and a length in a short direction are set such that a first vibration frequency vibrating in the longitudinal direction of the flat plate and a second vibration frequency vibrating in the short direction of the flat plate respectively resonate with mutually different vibration frequencies caused in the support plate around a portion where the fixation portion and the flat plate are joined.

Further features of the present invention will become apparent from the following description of exemplary embodiments with reference to the attached drawings.

### BRIEF DESCRIPTION OF THE DRAWINGS

FIG. 1 is an explanatory sectional view illustrating a configuration of an image forming apparatus including a drive transmission mechanism according to the present invention.

FIG. 2 is an explanatory perspective view illustrating a configuration of the image forming apparatus including a drive transmission mechanism according to the present invention.

FIG. 3 is an explanatory perspective view illustrating a configuration of a first embodiment of a drive transmission mechanism according to the present invention.

FIG. 4 is an explanatory perspective view illustrating a configuration of a drive transmission portion provided inside a drive unit in the image forming apparatus.

FIG. 5 is an explanatory plan view illustrating configurations of a drive source and a part of the drive transmission portion provided in the drive unit in the image forming apparatus.

FIG. 6 is an explanatory perspective view illustrating a configuration of the first embodiment in which a flat-plate member is integrally provided to a support member that support the drive source.

FIG. 7 is an explanatory perspective view illustrating a configuration of a flat-plate member made of an end portion center fixed-type rectangle applied to the first embodiment.

FIG. 8A is a diagram for describing a resonance phenomenon of the flat-plate member made of an end portion center fixed-type rectangle applied to the first embodiment.

FIG. 8B is a diagram for describing a resonance phenomenon of the flat-plate member made of an end portion center fixed-type rectangle applied to the first embodiment.

FIG. 8C is a diagram for describing a resonance phenomenon of the flat-plate member made of an end portion center fixed-type rectangle applied to the first embodiment.

FIG. 9 is an explanatory perspective view illustrating a configuration of a second embodiment of a drive transmission mechanism according to the present invention.

FIG. 10 is an explanatory perspective view illustrating a configuration of a flat-plate member made of an end portion center fixed-type rectangle applied to the second embodiment.

FIG. 11 is an explanatory perspective view illustrating a configuration of a third embodiment of a drive transmission mechanism according to the present invention.

FIG. 12 is an explanatory plan view illustrating configurations of a drive source and a part of a drive transmission portion provided in a drive unit of the third embodiment.

FIG. 13 is an explanatory perspective view illustrating a configuration of a flat-plate member made of a center fixed-type rectangle applied to the third embodiment.

FIG. 14A is a diagram for describing a resonance phenomenon of the flat-plate member made of a center fixed-type rectangle applied to the third embodiment.

FIG. 14B is a diagram for describing a resonance phenomenon of the flat-plate member made of a center fixed-type rectangle applied to the third embodiment.

FIG. 14C is a diagram for describing a resonance phenomenon of the flat-plate member made of a center fixed-type rectangle applied to the third embodiment.

FIG. 15A is an explanatory diagram illustrating a configuration of experimental equipment with which an excitation experiment of the flat-plate member made of a center fixed-type rectangle applied to the third embodiment is performed.

FIG. 15B is an explanatory sectional view illustrating a configuration of experimental equipment with which an excitation experiment of the flat-plate member made of a center fixed-type rectangle applied to the third embodiment is performed.

FIG. 16 is a diagram for describing a vibration phenomenon before and after the flat-plate member made of a center fixed-type rectangle applied to the third embodiment is mounted to a panel for excitation experiment.

FIG. 17 is an explanatory perspective view illustrating a configuration of a fourth embodiment of a flat-plate member made of a center fixed-type rectangle having two fixation portions.

FIG. 18A is a diagram for describing a resonance phenomenon of a flat-plate member made of an end portion center fixed-type ellipse applied to a fifth embodiment.

FIG. 18B is a diagram for describing a resonance phenomenon of the flat-plate member made of an end portion center fixed-type ellipse applied to the fifth embodiment.

FIG. 18C is a diagram for describing a resonance phenomenon of the flat-plate member made of an end portion center fixed-type ellipse applied to the fifth embodiment.

FIG. 19A is a diagram for describing a resonance phenomenon of a flat-plate member made of a center fixed-type ellipse applied to a sixth embodiment.

FIG. 19B is a diagram for describing a resonance phenomenon of the flat-plate member made of a center fixed-type ellipse applied to the sixth embodiment.

FIG. 19C is a diagram for describing a resonance phenomenon of the flat-plate member made of a center fixed-type ellipse applied to the sixth embodiment.

FIG. 20 is an explanatory perspective view illustrating a configuration of a drive unit of a comparative example.

### DESCRIPTION OF THE EMBODIMENTS

Embodiments of an image forming apparatus including a drive transmission mechanism according to the present invention will be specifically described with reference to the drawings.

### First Embodiment

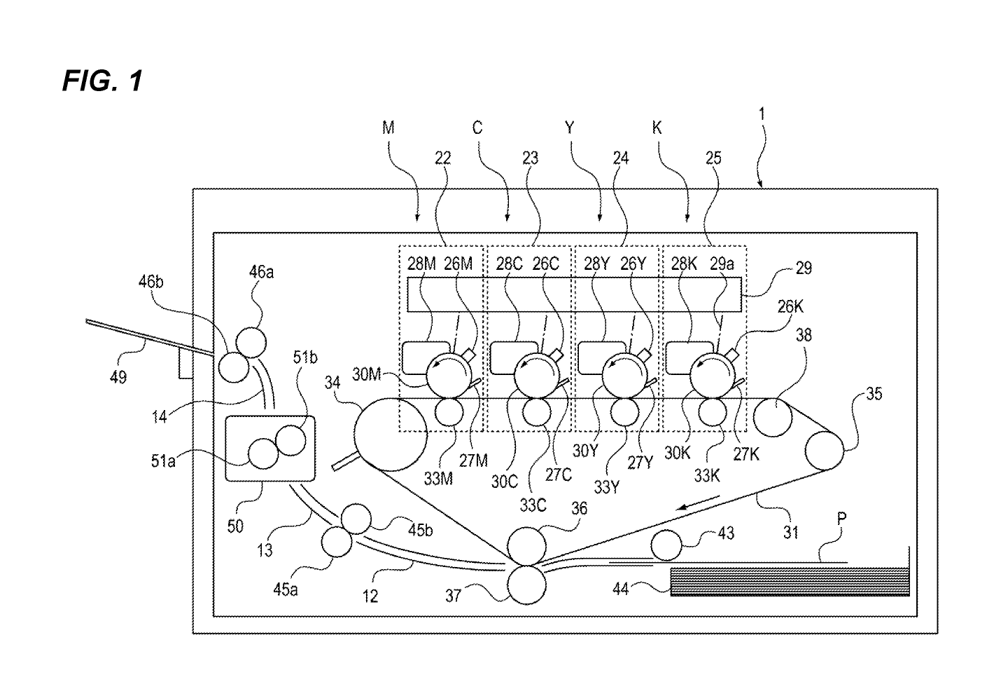

First, a configuration of a first embodiment of an image forming apparatus including a drive transmission mechanism according to the present invention will be described with reference to FIGS. 1 to 8.

### <Image Forming Apparatus>

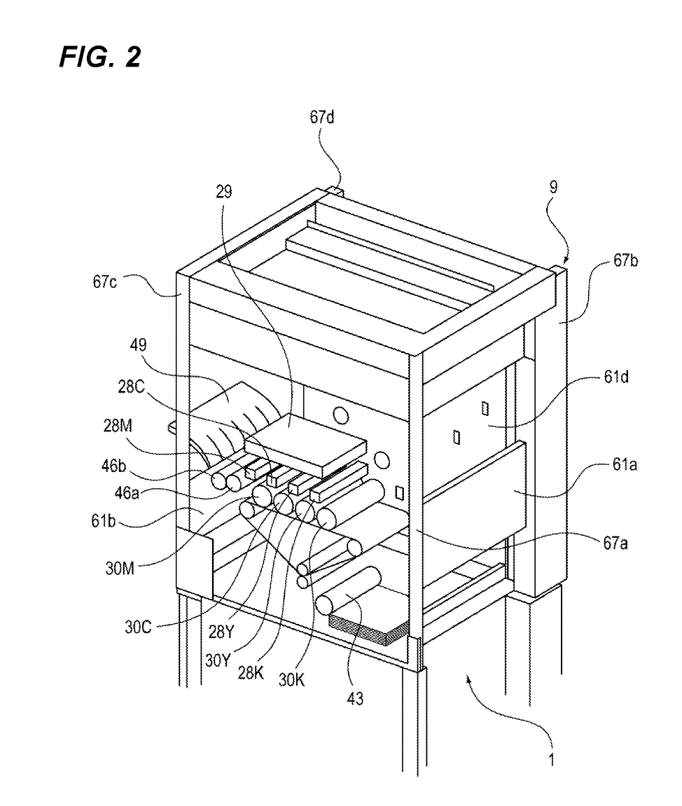

First, a configuration of a first embodiment of an image forming apparatus including a drive transmission mechanism according to the present invention will be described using FIGS. 1 and 2. FIG. 1 is a diagram schematically illustrating a periphery of an image forming portion of an image forming apparatus in an electrophotographic system.

An image forming apparatus 1 illustrated in FIG. 1 performs image formation on a recording material P based on a control signal from a printer controller (not illustrated).

In FIG. 1, configurations of an image forming portion 22 of magenta M, an image forming portion 23 of cyan C, an image forming portion 24 of yellow Y, and an image forming portion 25 of black K are approximately the same except for colors of developers. Hereinafter, the configuration of the image forming portion 25 of black K will be described as a representative of the image forming portions 22 to 25. Overlapping description of the other image forming portions 22 to 24 is omitted.

Further, photoconductor drums 30M, 30C, 30Y, and 30K of magenta M, cyan C, yellow Y, and black K may be simply described as photoconductor drum 30, as a representative. The same applies to the other image forming process portions.

In the present embodiment, the image forming apparatus 1 having the four image forming portions 22 to 25 will be described. However, an embodiment is not limited thereto. Further, other various forms are applicable to the arrangement of the image forming portions 22 to 25 in a main body of the image forming apparatus 1.

In the image forming portion 25 of black K, a charger 26 that serves as a charging portion charges a surface of the photoconductor drum 30 as an image bearing member to a predetermined potential, and performs preparation to form an electrostatic latent image.

An electrostatic latent image is formed by laser light 29a emitted from a laser scanner 29 that serves as an image exposing portion, on the surface of the photoconductor drum 30 uniformly charged by the charger 26.

A developing device 28 that serves as a developing portion develops the electrostatic latent image on the surface of the photoconductor drum 30, which is formed by the laser scanner 29, to form a toner image. Note that the developing device 28 is provided with a developing sleeve (not illustrated) that serves as a developer bearing member to which a developing bias voltage is applied to perform development.

An intermediate transfer belt 31 that serves as an intermediate transfer portion is rotatably stretched by a drive roller 34, a driven roller 35, a secondary transfer inner roller 36, and a tension roller 38.

A primary transfer roller 33 that serves as a primary transfer portion applies a transfer bias voltage from an inner peripheral surface side of the intermediate transfer belt 31, and primarily transfers the toner image on the surface of the photoconductor drum 30 onto an outer peripheral surface of the intermediate transfer belt 31.

When the primary transfer of the toner image on the outer peripheral surface of the intermediate transfer belt 31 ends, the toner remaining on the surface of the photoconductor drum 30 is scraped off by a cleaning blade 27 that serves as a cleaning portion, for the next image formation.

Meanwhile, the recording materials P are housed in a sheet cassette 44. The recording materials P are sent out from the sheet cassette 44 by a feed roller 43, and are separated and fed piece by piece by a separating portion (not illustrated). Then, the recording material P is conveyed to a secondary transfer portion including a secondary transfer inner roller 36 and a secondary transfer outer roller 37 with the intermediate transfer belt 31 lying therebetween.

The toner images of four colors primarily transferred on the outer peripheral surface of the intermediate transfer belt 31 from the photoconductor drums 30 of the image forming portions 22 to 25 are secondarily transferred to the recording material P in the secondary transfer portion. The recording material P is positioned to the toner image formed on the outer peripheral surface of the intermediate transfer belt 31 and fed.

Then, the recording material P on which the toner image is transferred is guided by a conveying guide 12, and nipped and conveyed by a conveying roller 45a and a driven roller 45b. Further, the recording material P is conveyed to a fixing device 50 that serves as a fixing portion through a conveying guide 13.

The recording material P on which the toner image is transferred is heated and pressurized while being nipped and conveyed by a heating roller 51a and a pressure roller 51b in the fixing device 50, and the toner image is fixed to the recording material P.

Following that, the recording material P to which the toner image is fixed is nipped by a discharge roller 46a and a driven roller 46b through a conveying guide 14 and discharged onto a discharge tray 49.

### <Drive Transmission Mechanism>

FIG. 2 is a perspective view of the image forming apparatus 1 from which an exterior cover of the image forming apparatus 1 is removed, and as viewed from a front right diagonal direction so that a body frame 9 and the like that configure a drive transmission mechanism can be seen. Note that, in FIG. 2, the conveying guides 12 to 14, the conveying roller 45a, the driven roller 45b, the fixing device 50, and the tension roller 38 illustrated in FIG. 1 are omitted for convenience of description.

As illustrated in FIG. 2, the image forming apparatus 1 of the present embodiment is supported by four support frames made of a right front support frame 67a, a right rear support frame 67b, a left front support frame 67c, and a left rear support frame 67d.

Further, a front side plate at a front side, a rear side plate 61d at a back side, a right side plate 61a, and a left side plate 61b (not illustrated) are respectively joined and provided between the support frames 67a to 67d. These support frames and side plates are configured as a body frame 9 of the image forming apparatus 1.

### COMPARATIVE EXAMPLE

<Drive Unit>

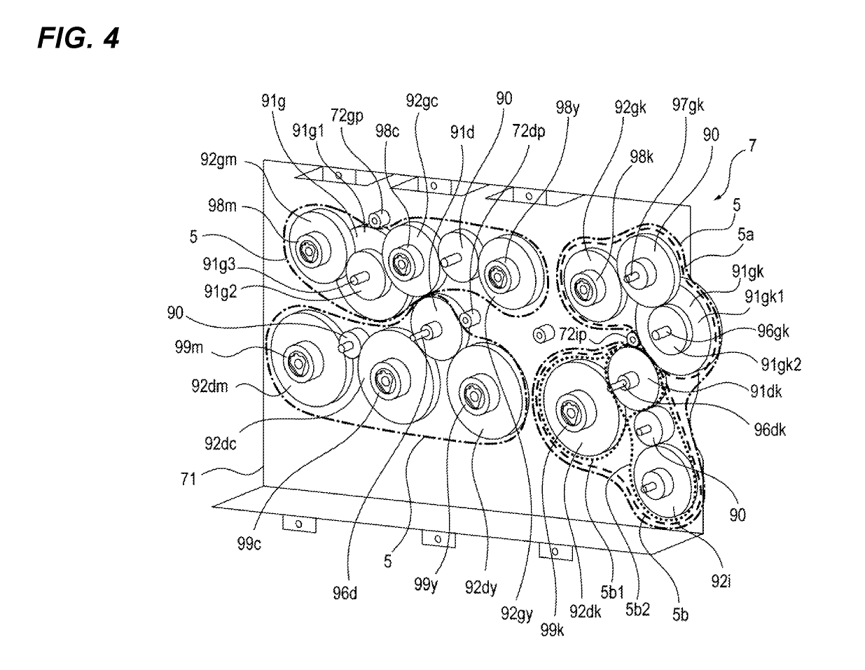

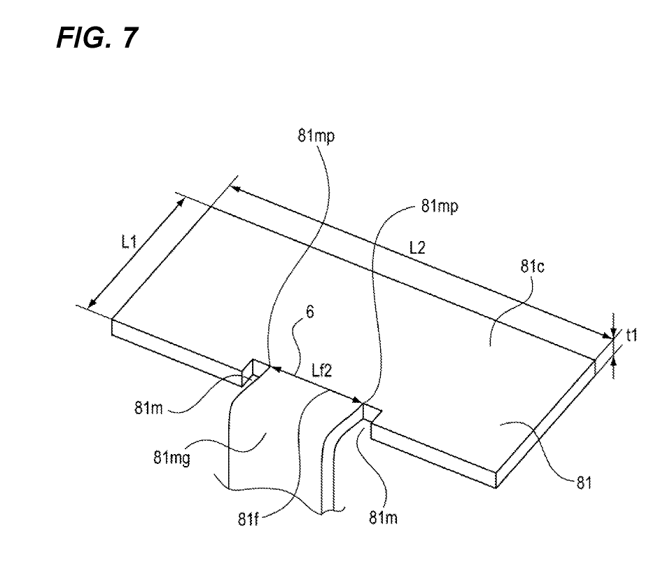

Next, a configuration of a rear sideplate 61d of an image forming apparatus 1 of a comparative example in which an end portion center fixed-type flat-plate member 81 illustrated in FIG. 7 is not provided will be described using FIGS. 4, 5, and 20 before description of the present embodiment is given.

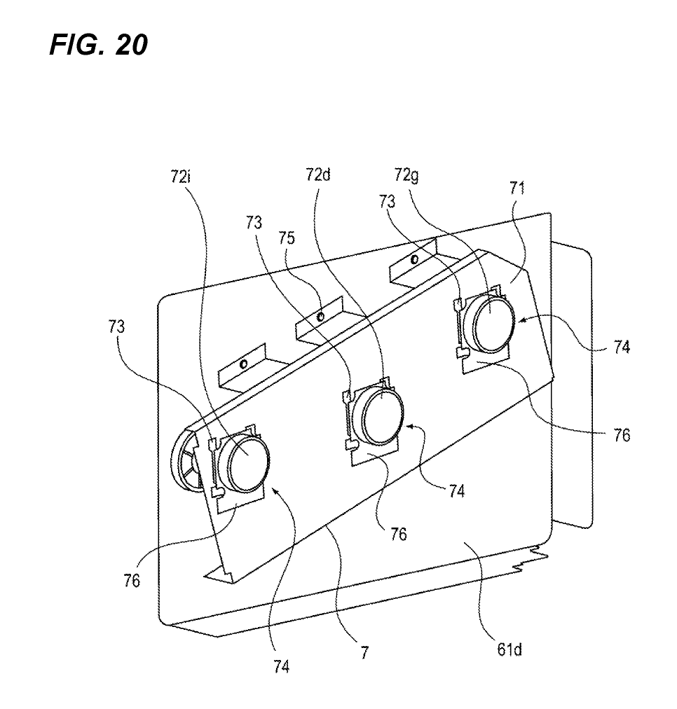

As illustrated in FIG. 20, a drive unit 7 is fixed to a back surface side (an outside) of the rear sideplate 61d. The drive unit 7 is fixed to the rear sideplate 61d by a fixing member such as a screw through a mounting hole 75.

To the drive unit 7, a motor 72i that rotates and drives an intermediate transfer belt 31, a photoconductor drum 30K of black K, and a developing device 28K of black K is fixed. Further, a motor 72d that rotates and drives photoconductor drums 30M, 30C, and 30Y of magenta M, cyan C, and yellow Y is fixed. Further, a motor 72g that rotates and drives developing devices 28M, 28C, and 28Y of magenta M, cyan C, and yellow Y is fixed.

The motors 72d, 72g, and 72i are configured as drive sources. Further, the intermediate transfer belt 31, the photoconductor drums 30M, 30C, 30Y, and 30K of magenta M, cyan C, yellow Y, and black K, and the developing devices 28M, 28C, 28Y, and 28K of magenta M, cyan C, yellow Y, and black K are configured as rotating members.

The motors 72d, 72g, and 72i are mounted on respective electrical substrates 76. The electrical substrate 76 receives a power supply voltage and a drive signal supplied from amain electrical portion (not illustrated) provided in the main body of the image forming apparatus 1, and converts the signal into a voltage signal that is directly provided to the motor 72d, 72g, or 72i.

Further, the electrical substrate 76 is mounted on a support plate 73 to configure a motor unit 74. Further, the motor unit 74 has the support plate 73 fixed onto a drive side plate 71 with a fixing member such as a screw.

### <Speed Reducer>

Next, a configuration of a speed reducer 5 provided in the drive unit 7 of the comparative example will be described using FIGS. 4 and 20. The speed reducer 5 is configured as a drive transmission portion that transmits rotational driving force from the drive sources (the motors 72d, 72g, and 72i) to the rotating members (the intermediate transfer belt 31, the photoconductor drums 30, and the developing device 28).

The three motors 72d, 72g, and 72i illustrated in FIG. 20 and mounted on the drive unit 7 of the comparative example illustrated in FIG. 4 play a role of the drive sources of the intermediate transfer belt 31, the photoconductor drums 30, and the developing devices 28 that serve as the rotating members.

### <Motor Rotating and Driving Intermediate Transfer Belt>

In the comparative example illustrated in FIGS. 4 and 20, a pinion gear 72ip illustrated in FIG. 4 is fixed to a rotating shaft of the motor 72i that rotates and drives the intermediate transfer belt 31, and the photoconductor drum 30K and the developing device 28K of black K. Drive distribution is given from the pinion gear 72ip by the speed reducer 5 that includes a gear train illustrated in FIG. 4.

The speed reducer 5 is divided into two systems including a speed reducer 5a made of a gear train that rotates and drives the developing device 28K of black K, and a speed reducer 5b made of a gear train that rotates and drives the intermediate transfer belt 31 and the photoconductor drum 30K of black K.

In the speed reducer 5a that serves as a gear train of the first system illustrated in FIG. 4, the rotational driving force is transmitted from the pinion gear 72ip fixed to the rotating shaft of the motor 72i to a large-diameter gear 91gk1 of an initial gear 91gk made of a two-stage gear that rotates and drives the developing device 28K of black K.

Then, the rotational driving force is transmitted from a small-diameter gear 91gk2 of the initial gear 91gk to a lower gear 92gk that rotates and drives the developing device 28K of black K through an idler gear 90 made of a two-stage gear.

A coupling 98k is attached to a tip portion of a rotation shaft of the lower gear 92gk, and the rotating driving force transmitted to the lower gear 92gk through the coupling 98k is transmitted to the developing device 28K of black K.

In the speed reducer 5b that serves as a gear train of the second system illustrated in FIG. 4, the rotational driving force is transmitted from the pinion gear 72ip fixed to the rotating shaft of the motor 72i to an initial gear 91dk that rotates and drives the photoconductor drum 30K of black K. From the initial gear 91dk, the speed reducer 5b is further divided into two systems including speed reducers 5b1 and 5b2 made of a gear train.

In the speed reducer 5b1 that serves as the third system illustrated in FIG. 4, the rotational driving force is transmitted from the pinion gear 72ip to a lower gear 92dk that rotates and drives the photoconductor drum 30K of black K through the initial gear 91dk. A coupling 99k that can be coupled with a rotating shaft of the photoconductor drum 30K is attached to a rotating shaft of the lower gear 92dk. Accordingly, the rotational driving force transmitted to the lower gear 92dk through the coupling 99k is transmitted to the photoconductor drum 30K of black K.

The rotational driving force is transmitted from the pinion gear 72ip fixed to the rotating shaft of the motor 72i to the initial gear 91dk that rotates and drives the photoconductor drum 30K of black K. The rotational driving force rotates and drives a lower gear 92i that rotates and drives the intermediate transfer belt 31 through the idler gear 90 of the speed reducer 5b2 made of a gear train and serving as the fourth system illustrated in FIG. 4.

A rotating shaft of the drive roller 34 that rotates and drives the intermediate transfer belt 31 is coupled to a rotating shaft of the lower gear 92i. The rotational driving force transmitted from the pinion gear 72ip fixed to the rotating shaft of the motor 72i to the initial gear 91dk is transmitted to the drive roller 34 through the speed reducer 5b2, and rotates and drives the intermediate transfer belt 31.

In the drive unit 7 of the comparative example illustrated in FIG. 4, the developing device 28K of black K and the photoconductor drum 30K of black K are rotated and driven using the motor 72i that rotates and drives the intermediate transfer belt 31.

### <Motors Rotating and Driving Photoconductor Drums of Magenta, Cyan, and Yellow>

In the comparative example illustrated in FIG. 20, a pinion gear 72dp illustrated in FIG. 4 is fixed to a rotating shaft of the motor 72d that rotates and drives the photoconductor drums 30M, 30C, and 30Y of magenta M, cyan C, and yellow Y.

The rotational driving force transmitted from the motor 72d to the pinion gear 72dp is transmitted to the initial gear 91d that serves as a speed reducer that rotates and drives the photoconductor drums 30M, 30C, and 30Y of magenta M, cyan C, and yellow Y.

The rotational driving force of the motor 72d is transmitted to the initial gear 91d meshed with the pinion gear 72dp. Following that, the drive distribution is given from the initial gear 91d to two systems including a lower gear 92dy that rotates and drives the photoconductor drum 30Y of yellow Y and a lower gear 92dc that rotates and drives the photoconductor drum 30C of cyan C.

Further, the rotational driving force is transmitted from the lower gear 92dc that rotates and drives the photoconductor drum 30C of cyan C to a lower gear 92dm that rotates and drives the photoconductor drum 30M of magenta M through the idler gear 90.

The photoconductor drums 30M, 30C, and 30Y of magenta M, cyan C, and yellow Y are respectively rotated and driven by the lower gears 92dm, 92dc, and 92dy. Couplings 99m, 99c, and 99y that can be coupled with the rotating shafts of the photoconductor drums 30M, 30C, and 30Y are fixed to rotating shafts of the lower gears 92dm, 92dc, and 92dy.

Accordingly, the photoconductor drums 30M, 30C, and 30Y of magenta M, cyan C, and yellow Y are rotated and driven through the couplings 99m, 99c, and 99y.

### <Motors Rotating and Driving Developing Devices of Magenta, Cyan, and Yellow>

In the comparative example illustrated in FIG. 20, a pinion gear 72gp illustrated in FIG. 4 is fixed to a rotating shaft 72g1 of the motor 72g that rotates and drives the developing devices 28M, 28C, an 28Y of magenta M, cyan C, and yellow Y.

The rotational driving force of the motor 72g is transmitted to a large-diameter gear 91g1 of an initial gear 91g that serves as a speed reducer made of a two-stage gear meshed with the pinion gear 72gp.

The rotational driving force is transmitted from a small-diameter gear 91g2 of the initial gear 91g to a lower gear 92gm that rotates and drives the developing device 28M of magenta M, and a lower gear 92gc that rotates and drives the developing device 28C of cyan C.

The rotational driving force is transmitted to a lower gear 92gy that rotates and drives the developing device 28Y of yellow Y through the idler gear 90 meshed with the lower gear 92gc that rotates and drives the developing device 28C of cyan C.

Couplings 98m, 98c, and 98y that can be coupled with rotated and driven portions of the developing devices 28M, 28C, and 28Y are fixed to the respective lower gears 92gm, 92gc, and 92gy. Accordingly, the developing devices 28M, 28C, and 28Y of magenta M, cyan C, and yellow Y can be rotated and driven through the couplings 98m, 98c, and 98y.

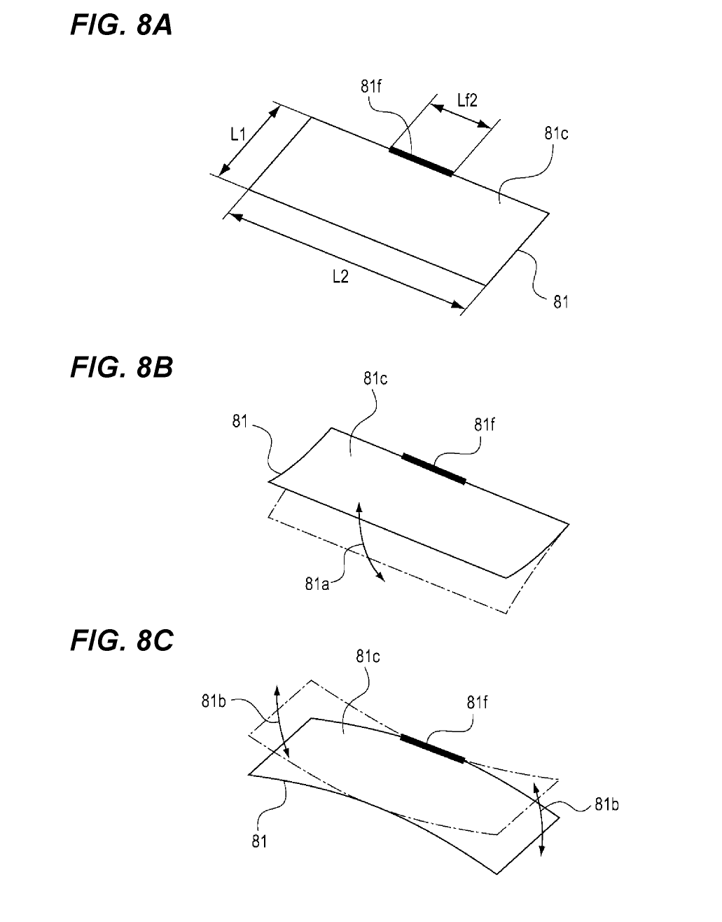

The gear trains illustrated in FIG. 4 are configured as drive transmission portions. The drive transmission portions transmit the rotational driving force from the motors 72d, 72g, and 72i that serve as the drive sources illustrated in FIG. 8 to the intermediate transfer belt 31, the photoconductor drums 30M, 30C, 30Y, and 30K, and the developing devices 28M, 28C, 28Y, and 28K, which serve as the rotating members.

Further, the large-diameter gear 91gk1 and the initial gear 91dk of the initial gear 91gk meshed with the pinion gear 72ip illustrated in FIG. 4 configured as the drive transmission portion are configured as the speed reducers in which the gears are meshed with each other. Further, the large-diameter gear 91g1 of the initial gear 91g meshed with the pinion gear 72gp is also configured as the speed reducer in which the gears are meshed with each other. Further, the initial gear 91d meshed with the pinion gear 72dp is also configured as the speed reducer in which the gears are meshed with each other.

### <Generation of Noises in Drive Unit>

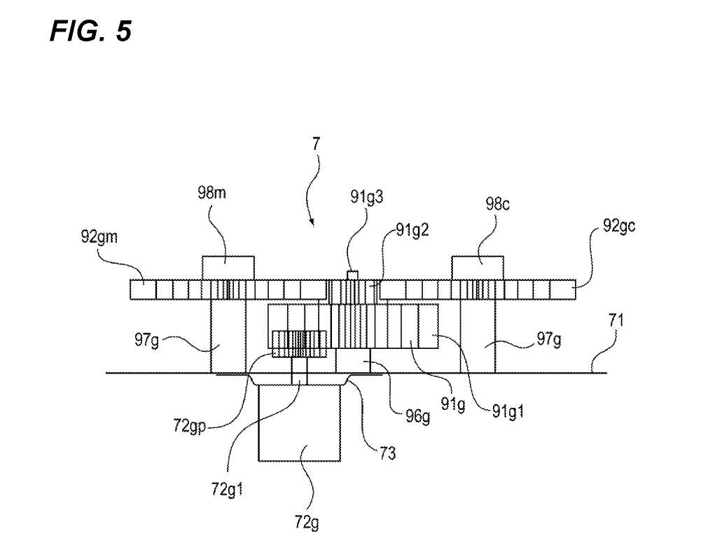

Next, causes of generation of noises due to vibration in the drive unit 7 of the comparative example will be described using FIG. 5. FIG. 5 is an explanatory plan view of a vicinity of the motor 72g as viewed above, which rotates and drives the developing devices 28M, 28C, and 28Y of magenta M, cyan C, and yellow Y provided in the drive unit 7 of the comparative example illustrated in FIGS. 4 and 20.

In the image forming apparatus 1 illustrated in FIGS. 1 and 2, an image forming operation is started by a control command from a printer controller (not illustrated). Then, the three motors 72d, 72g, and 72i provided in the drive unit 7 of the comparative example illustrated in FIGS. 4 and 20 are rotated and driven.

In the comparative example illustrated in FIG. 5, the developing devices 28M, 28C, and 28Y of magenta M, cyan C, and yellow Y are rotated and driven by the motor 72g. Causes of generation of noises due to vibration in the drive unit 7 in a case where the motor 72g is rotated will be described below.

The causes of generation of noises due to vibration in the drive unit 7 in the comparative example illustrated in FIGS. 4 and 20 are as follows. The same applies to a case where the motor 72i is rotated, the motor 72i rotating and driving the intermediate transfer belt 31, the developing device 28K of black K, and the photoconductor drum 30K of black K.

The same applies to a case where the motor 72d is rotated, the motor 72d rotating and driving the photoconductor drums 30M, 30C, and 30Y of magenta M, cyan C, and yellow Y. Therefore, overlapping description of the causes of generation of noises due to vibration in the drive unit 7 of the cases where the motors 72d and 72i are rotated is omitted.

In the comparative example illustrated in FIG. 5, the motor 72g that rotates and drives the developing device 28M, 28C, 28Y of magenta M, cyan C, and yellow Y is rotated. Then, the pinion gear 72gp integrally fixed to the rotating shaft 72g1 of the motor 72g that rotates and drives the developing devices 28M and 28C of magenta M and cyan C illustrated in FIG. 5 is also rotated at the same time.

The pinion gear 72gp is meshed with the large-diameter gear 91g1 of the initial gear 91g. The pinion gear 72gp is configured from a smaller-diameter gear than the large-diameter gear 91g1. Accordingly a speed reducer that reduces a rotational speed of the initial gear 91g with respect to a rotational speed of the pinion gear 72gp according to a gear ratio between the pinion gear 72gp and the large-diameter gear 91g1 is configured.

Further, the small-diameter gear 91g2 of the initial gear 91g is meshed with the lower gear 92gm that rotates and drives the developing device 28M of magenta M, and the lower gear 92gc that rotates and drives the developing device 28C of cyan C. The small-diameter gear 91g2 is configured from a smaller-diameter gear than the lower gears 92gc and 92gm.

Accordingly, a speed reducer that reduces a rotational speed of the lower gears 92gc and 92gm with respect to the rotational speed of the initial gear 91g according to a gear ratio between the small-diameter gear 91g2 of the initial gear 91g and the lower gears 92gc and 92gm is configured.

That is, the rotational speed of the lower gears 92gc and 92gm is further reduced through the small-diameter gear 91g2 of the initial gear 91g configured as a speed reducer, with respect to the rotational speed of the pinion gear 72gp integrally rotated with the rotating shaft 72g1 of the motor 72g. All of the pinion gear 72gp, the initial gear 91g, and the lower gears 92gc and 92gm illustrated in the comparative example of FIG. 5 are configured from spur gears.

As illustrated in FIG. 4, the couplings 98c and 98m are respectively attached to the rotating shafts of the lower gear 92gc that rotates and drives the developing device 28C of cyan C and the lower gear 92gm that rotates and drives the developing device 28M of magenta M.

The rotated and driven portions (not illustrated) of the developing device 28C of cyan C and the developing device 28M of magenta M are respectively coupled with the couplings 98c and 98m. Accordingly, the rotational driving force is transmitted to the developing device 28C of cyan C and the developing device 28M of magenta M.

The motor 72g illustrated in the comparative example of FIG. 5 is fixed to the drive sideplate 71 through the support plate 73. The rotating shaft 72g1 of the pinion gear 72gp is rotatably provided to penetrate the drive side plate 71. Meanwhile, respective rotating shafts of the initial gear 91g and the lower gears 92gc and 92gm are rotatably supported by support shafts 96g and 97g fixed to the drive side plate 71.

For example, a rotating shaft 91g3 of the initial gear 91g illustrated in the comparative example of FIG. 5 is rotatably supported by the support shaft 96g, and the support shaft 96g is fastened to the drive sideplate 71 with a fixation portion such as a screw or caulking.

In the drive unit 7 illustrated in the comparative example of FIG. 5, the motor 72g that rotates and drives the developing devices 28M, 28C, and 28Y of magenta M, cyan C, and yellow Y is rotated. Then, vibration radiation sounds are generated from the portions of the drive unit 7.

Among the vibration radiation sounds, the vibration radiation sounds radiated from the drive sideplate 71 as a frame structure body by which the motor 72g, the initial gear 91g, and the lower gears 92gc and 92gm are supported are one major cause of generation of noises due to vibration in the drive unit 7.

Two causes of generation of the vibration radiation sounds radiating from the drive side plate 71 as the frame structure body are basically as follows.

The first cause of the vibration radiation sounds is an own periodical vibration phenomenon of the motor 72g that rotates and drives the developing devices 28M, 28C, and 28Y of magenta M, cyan C, and yellow Y.

The second cause of the vibration radiation sounds is mesh vibration between the pinion gear 72gp and the large-diameter gear 91g1 of the initial gear 91g illustrated in FIGS. 4 and 5.

### <Vibration Radiation Sounds Due to Periodical Vibration Phenomenon of Motor>

For example, a two-phase stepping motor (a stepping motor having two sets of excitation winding in a stator) is employed as the motor 72g that rotates and drives the developing devices 28M, 28C, and 28Y of magenta M, cyan C, and yellow Y. Then, a case where the motor 72g is rotated by full-step drive of 900 rpm (the rotational speed per minute) will be considered.

A basic step angle of the two-phase stepping motor employed as the motor 72g is 1.8° (degrees). Therefore, applied pulses necessary to rotate the two-phase stepping motor once are 200 pulses (=360°/1.8°).

When the two-phase stepping motor is rotated at 900 rpm, the two-phase stepping motor is rotated 15 times in one second (=900 time of rotation/60 seconds). Therefore, the two-phase stepping motor configured as the motor 72g is rotated with a period of 15 (times of rotation)×200 (pulses)=3000 (Hz) as a basic frequency. The motor 72g rotates and drives the developing devices 28M, 28C, and 28Y of magenta M, cyan C, and yellow Y.

The motor 72g made of the two-phase stepping motor is rotated with the period of 3000 Hz as a basic frequency. Vibration in accordance with the applied period of the drive pulse is generated from the motor stator (stator) from the structural aspect of the two-phase stepping motor.

The vibration has an integral multiple component of the rotational frequency of the motor 72g that serves as the drive source. This vibration is transmitted from the motor 72g to the drive side plate 71 through the support plate 73. As a result, the vibration radiation sounds are generated from the drive side plate 71 as the frame structure body.

<Vibration Radiation Sounds Due to Mesh Vibration between Pinion Gear and Initial Gear>

For example, assume that the number of teeth of the pinion gear 72gp illustrated in the comparative example of FIG. 5 is 16 (teeth). In that case, the motor 72g made of the two-phase stepping motor is rotated at 900 rpm.

Then, the pinion gear 72gp is also rotated by 15 times of rotation in one second (=900 times of rotation/60 seconds). Then, the pinion gear 72gp and the large-diameter gear 91g1 of the initial gear 91g illustrated in FIGS. 4 and 5 are meshed at 15 (times of rotation/sec (second))×16 (the number of teeth)=240 Hz.

Manufacturing variations are caused in the actual drive unit 7. For example, it is difficult to attach the motor 72g, the support shafts 96g and 97g, and the like to the drive side plate 71 illustrated in FIGS. 4 and 5 without errors (tolerances). Therefore, typically, the pinion gear 72gp and the large-diameter gear 91g1 of the initial gear 91g are meshed in a state where a certain amount of alignment (alignment condition) error is caused.

As a result, alignment between the pinion gear 72gp made of two spur gears and the large-diameter gear 91g1 of the initial gear 91g breaks. Then, the basic frequency component of 240 Hz from the initial gear 91g through the support shaft 96g and an order component thereof are composited and vibrate the drive side plate 71. This becomes a frequency of vibration excitation generated from the drive transmission portion.

Further, reaction force acts on the pinion gear 72gp from the large-diameter gear 91g1 of the initial gear 91g illustrated in FIG. 5, and the reaction force shakes the drive side plate 71 through the motor 72g and the support plate 73. As a result, the drive side plate 71 as the frame structure body vibrates and generates the vibration radiation sounds.

For a similar reason, the drive side plate 71 may be shaken through the support shaft 97g that rotatably supports the rotating shafts of the lower gears 92gc and 92gm meshed with the small-diameter gear 91g2 of the initial gear 91g illustrated in FIG. 5. A basic principle is similar to the above-described second cause, and thus overlapping description is omitted.

As the cause of generation of noises due to vibration in the drive unit 7, an influence of the vibration radiation sounds from the drive side plate 71 cannot be ignored. Especially, the vibration due to the own rotation of the motor 72g, and the mesh vibration between the pinion gear 72gp and the large-diameter gear 91g1 of the initial gear 91g are two major causes.

A particular problem in the first and second causes is that the vibration including a plurality of frequency components shakes the drive sideplate 71, rather than vibration of a single frequency.

For example, as for the phenomenon of the second cause, the pinion gear 72gp and the large-diameter gear 91g1 of the initial gear 91g as the speed reducer are meshed with each other at the frequency of 240 Hz. In reality, the drive side plate 71 is shaken at the vibration excitation frequency of 240×n (n is an integer) Hz that is an order component of 240 Hz as the basic frequency.

Therefore, the technology corresponding to one frequency, like Japanese Patent Laid-Open No. 2010-032011 cannot sufficiently suppress the vibration radiation sounds of the drive side plate 71 as the frame structure body.

### <Vibration Absorption>

To suppress the vibration radiation sounds of the drive side plate 71 as the frame structure body in the image forming apparatus 1, it is necessary to suppress noises generated by the plurality of vibration frequencies existing for the above-described reason.

The image forming apparatus 1 that is an object from which the vibration radiation sounds are suppressed has an extremely smaller space in which a vibration absorption component is arranged than other products such as automobiles. Further, there are also cost limitations, and new addition of a costly component may often be difficult. Therefore, it is necessary to suppress at least two (a plurality of) vibration frequencies with limited space and at low cost.

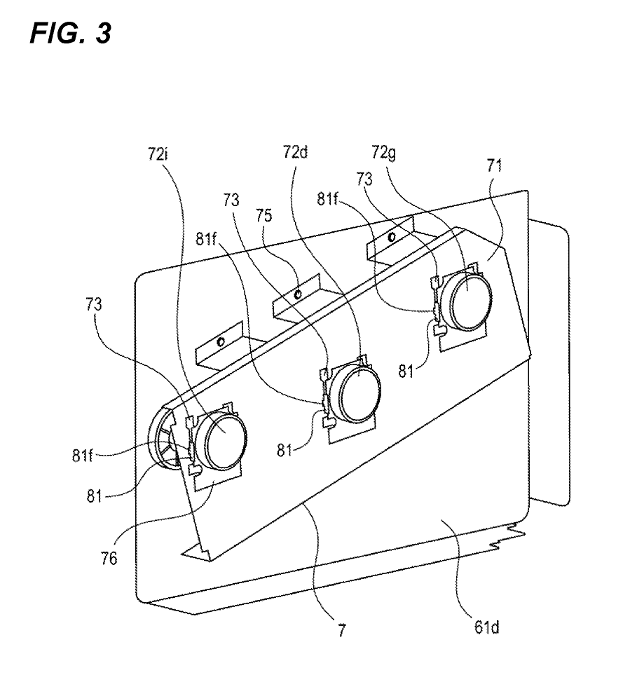

In the present embodiment, as illustrated in FIG. 7, the flat-plate member 81 made of a rectangle having long sides and short sides, which can suppress at least two (a plurality of) vibration frequencies with limited space and at low cost, is used. Then, as illustrated in FIG. 3, the flat-plate member 81 is fixed to the support plate 73 that serves as a support member fixed to the drive side plate 71 of the drive unit 7, as follows. Any central portion of the sides (the long sides and the short sides) of the flat-plate member 81 is fixed with one or more (one in the present embodiment) fixation portions 81f without fixing end portions of the sides (the long sides and the short sides) of the rectangle of the flat-plate member 81.

In the present embodiment, as illustrated in FIG. 7, a vicinity of a central portion of a long side of the rectangle is fixed without fixing any of both end portions of the sides of the rectangle (that is, four corners of the rectangle) of the flat-plate member 81 made of the rectangle.

Accordingly, as compared with the attenuating member of Japanese Patent Laid-Open No. 2009-257463, the degree of freedom of the vibration motion of the flat-plate member 81 is improved, and the degree of freedom of selectable two vibration frequencies is improved. The selectable two vibration frequencies are vibration frequencies f1 and f2 (Hz) corresponding to the length of the long sides and the length of the short sides of the flat-plate member 81 made of one rectangle. Then, the flat-plate member 81 can control the vibration frequencies f1 and f2 (Hz) relatively independently of each other although the control is not fully independent because the sides in the long axial direction and the short axial direction integrally perform vibration motion.

Note that the flat-plate member 81 made of a rectangle may be provided with curved portions (arc portions) at the four corners of the rectangle or may be linearly chamfered.

In the flat-plate member 81 made of a rectangle illustrated in FIG. 7, a long-side dimension L2 that is a fixed side is desirably longer than a short-side dimension L1. Accordingly, vibration motion 81b in a longitudinal direction of the flat-plate member 81, illustrated in FIG. 8C, can be easily generated. Accordingly, the vibration frequencies f1 and f2 (Hz) can be generated relatively independently of each other although the generation is not fully independent.

The relationship between the long-side dimension L2 and the short-side dimension L1 of the flat-plate member 81 made of a rectangle illustrated in FIG. 7 is not necessarily limited thereto. However, in a case where the fixed side is provided in the short side, the vibration motion 81b in the longitudinal direction of the flat-plate member 81 illustrated in FIG. 8C becomes difficult, and relatively independent generation of the vibration frequencies f1 and f2 (Hz) although not fully independent become difficult.

The flat-plate member 81 made of a rectangle illustrated in FIG. 7 is provided in the image forming apparatus 1, so that the vibration radiation sounds of the drive sideplate 71 as the frame structure body are decreased. To achieve that, suppression of vibration of the main system structure body, the vibration being made of a plurality of vibration frequencies, using the flat-plate member 81 made of a rectangle, which achieves space saving and low cost, and less variation, is required.

That is, it is desired that the flat-plate member 81 made of one rectangle is fixed to the drive side plate 71 as the frame structure body, and can absorb at least two vibration frequencies.

Further, a configuration to fix the flat-plate member 81 made of a rectangle to the drive side plate 71 as the frame structure body that is a vibration body at one place is desired to achieve space saving in the image forming apparatus 1.

Further, if the flat-plate member 81 made of a rectangle can be configured from the same component as the vibrating component of the image forming apparatus 1, space saving and low cost can be achieved.

In the present embodiment, the support plate 73 that serves as a support member to which the flat-plate member 81 made of a rectangle is fixed with the fixation portion 81f supports the motors 72d, 72g, and 72i that serve as the drive sources. The flat-plate member 81 made of a rectangle of the present embodiment is configured from the same member as the support plate 73 that serves as the support member.

Further, for the flat-plate member 81, a metal material such as zinc coated steel sheet including ZINKOTE (registered trademark) manufactured by NIPPON STEEL & SUMITOMO METAL CORPORATION, or stainless steel sheet may be used. Alternatively, a resin material such as acrylonitrilebutadiene styrene copolymer (ABS) maybe used. Alternatively, to obtain a more substantial damping effect, damping steel sheet in which damping rubber is sandwiched between two metal plates, or damping alloy that is an alloy material that absorbs vibration can be used.

As the damping steel sheet, a rubber laminate damping steel sheet such as METALAMINE (registered trademark) manufactured by NICHIAS CORPORATION is applicable. Further, as the damping alloy, a damping alloy containing 20% by weight of copper, 5% by weight of nickel, and 2% by weight of iron based on manganese in M2052 (product name) manufactured by SEISIN ENGINEERING CORPORATION is applicable.

As illustrated in FIG. 7, in the flat-plate member 81 made of a rectangle of the present embodiment, a flat-plate portion 81c is configured from a rectangle. The fixation portion 81f is provided in a part (central portion) of one side (long side) around the flat-plate portion 81c.

Accordingly, the vibration radiation sounds of the drive side plate 71 that serves as the frame structure body due to vibration excited with two frequencies are suppressed.

### <Flat-Plate Member Made of End Portion Center Fixed-Type Rectangle>

Next, the configuration of the flat-plate member 81 made of a rectangle of the present embodiment will be described using FIG. 7. The flat-plate member 81 made of a rectangle illustrated in FIG. 7 is provided with the fixation portion 81f in a part (central portion) of a long side of the flat-plate portion 81c made of a rectangular sheet metal flat plate having the short-side dimension L1 and the long-side dimension L2.

The flat-plate member 81 made of a rectangle illustrated in FIG. 7 has a bent portion 81mg formed such that a sheet metal is bent from a vicinity of the fixation portion 81f provided in the central portion of the long side of the flat-plate portion 81c. Bend relief portions 81m made of a cut portion are formed in both end portions of the fixation portion 81f.

As illustrated in FIG. 7, fixed end portions 81mp are formed at boundary portions of the bent portion 81mg and the bend relief portions 81m. In the flat-plate member 81 made of a rectangle illustrated in FIG. 7, the length of a line segment 6 that connects the two fixed end portions 81mp is Lf2, and a region at the side of the flat-plate portion 81c with respect to the line segment 6 is defined as a damping portion of the flat-plate member 81 made of a rectangle. Further, a region at a side opposite to the flat-plate portion 81c with respect to the line segment 6 is defined as the bent portion 81mg.

In the flat-plate member 81 made of a rectangle illustrated in FIG. 7, the fixation portion 81f is a region of the line segment 6 that connects the two fixed end portions 81mp.

In the present embodiment, the fixation portion 81f that is the region of the line segment 6 that connects the two fixed end portions 81mp is fixed to the support plate 73 fixed to the drive side plate 71 of the drive unit 7. The area of the flat-plate portion 81c is set to be larger than the area of the fixing region (the region corresponding to the line segment 6). Further, the fixation portion 81f is provided in a part (central portion) of one side (long side) of the flat-plate portion 81c.

In Japanese Patent Laid-Open No. 2009-257463, the region made by connecting the line segments of the fixation portion becomes equal to the area of the flat-plate portion. Therefore, the fixation portion extends around the flat-plate portion. Therefore, application to the image forming apparatus 1, which requires space saving, is difficult.

Meanwhile, in the present embodiment, the flat-plate portion 81c of the flat-plate member 81 made of a rectangle is supported by the fixation portion 81f in a cantilever manner, as illustrated in FIG. 7. Accordingly, the space required to fix the flat-plate member 81 made of a rectangle becomes small, and is sufficiently applicable to the image forming apparatus 1 with an extremely limited excessive space.

Further, in the present embodiment, the flat-plate portion 81c that serves as the damping portion and the fixation portion 81f are configured from the same component. Therefore, as compared with Japanese Patent Laid-Open No. 2010-032011, the product cost can be decreased, and further, the variation of the vibration frequency absorbed by the flat-plate portion 81c that serves as the damping portion can be suppressed.

### <Damping Motion>

Next, damping motion of the flat-plate member 81 made of a rectangle illustrated in FIG. 7 will be described using FIGS. 8A to 8C. When no vibration is applied to the flat-plate member 81 made of a rectangle illustrated in FIG. 7, and the flat-plate member 81 is not moved, the flat-plate member 81 made of a rectangle remains flat, as illustrated in FIG. 8A.

However, when the vibration of the drive side plate 71 of the drive unit 7 is applied to the flat-plate member 81 made of a rectangle through the support plate 73 (drive transmission member), the damping motion illustrated in FIGS. 8B and 8C is generated by the flat-plate member 81.

As illustrated in FIGS. 8A to 8C, the fixation portion 81f of the flat-plate member 81 made of a rectangle is provided in a part (central portion) of a one side (long side) region of the flat-plate portion 81c. Accordingly, as illustrate in FIG. 8B, in the flat-plate member 81 made of a rectangle, nodding motion 81a along a circumference centered at the fixation portion 81f (vibration in an up and down direction of FIG. 8B centered at the fixation portion 81f) can be generated at the vibration frequency f1 (Hz).

Further, as illustrated in FIG. 8C, a resonance phenomenon in which the vibration motion 81b in the longitudinal direction, which vibrates both sides of the fixation portion 81f in the longitudinal direction, is performed at the vibration frequency f2 (Hz) can be generated.

In the present embodiment, the two vibration frequencies f1 and f2 (Hz) are absorbed by the flat-plate member 81 made of a rectangle by use of the independent vibration phenomena in the two directions illustrated in FIGS. 8B and 8C.

For example, if the fixation portion 81f of the flat-plate member 81 made of a rectangle has a cantilever shape having an equivalent length to the long-side dimension L2 of the flat-plate portion 81c illustrated in FIG. 7, the vibration motion 81b in the longitudinal direction of the fixation portion 81f illustrated in FIG. 8C cannot be generated.

Therefore, in the present embodiment, the length Lf2 of the fixation portion 81f in the longitudinal direction illustrated in FIG. 7 needs to be shorter than the long-side dimension L2 of the flat-plate portion 81c.

Further, in the present embodiment, as illustrated in FIG. 8B, the nodding motion 81a along the circumference centered at the fixation portion 81f of the flat-plate member 81 made of a rectangle is generated. Further, as illustrated in FIG. 8C, the vibration motion 81b in the longitudinal direction, which vibrates the both sides of the fixation portion 81f in the longitudinal direction, is generated. The nodding motion 81a along the circumference centered at the fixation portion 81f illustrated in FIG. 8B and the vibration motion 81b in the longitudinal direction illustrated in FIG. 8C are generated as vibration in two perpendicular directions.

The vibration frequencies f1 and f2 (Hz) can be controlled by appropriately changing the short-side dimension L1 and the long-side dimension L2 of the flat-plate portion 81c illustrated in FIG. 8A. In theory, although the nodding motion 81a in a short direction and the vibration motion 81b in the longitudinal direction are not fully independent of each other, the vibration frequencies f1 and f2 (Hz) can be relatively independently controlled.

To be more specific, in the flat-plate member 81, the length Lf2 of the fixation portion 81f in the longitudinal direction is 20 mm, the long-side dimension L2 of the flat-plate portion 81c is 100 mm, and the short-side dimension L1 is 40 mm. When the material of the flat-plate member 81 is iron, the vibration frequency (resonant frequency) f1 of the nodding motion 81a in the short direction illustrated in FIG. 8B is calculated as 184 Hz. Further, the vibration frequency (resonant frequency) f2 of the vibration motion 81b in the longitudinal direction illustrated in FIG. 8C is calculated as 377 Hz.

For example, only the short-side dimension L1 of the flat-plate portion 81c of the flat-plate member 81 is made long. Then, the vibration frequency (resonant frequency) f1 of the nodding motion 81a in the short direction illustrated in FIG. 8B can be adjusted without affecting the vibration frequency (resonant frequency) f2 of the vibration motion 81b in the longitudinal direction illustrated in FIG. 8C.

When the thickness, the short-side dimension L1, and the long-side dimension L2 of the flat-plate portion 81c of the flat-plate member 81 are changed, the resonant frequency of the flat-plate member 81 is changed. Therefore, the short-side dimension L1, the long-side dimension L2, and the thickness of the flat-plate portion 81c of the flat-plate member 81 are appropriately set in accordance with the vibration frequency to be decreased.

For example, the short-side dimension L1 of the flat-plate portion 81c illustrated in FIG. 8A is changed. Then, the vibration frequency f1 of the nodding motion 81a along the circumference centered at the fixation portion 81f of the flat-plate member 81 made of a rectangle illustrated in FIG. 8B can be substantially changed.

Meanwhile, even if the short-side dimension L1 of the flat-plate portion 81c illustrated in FIG. 8A is changed, the vibration frequency f2 of the vibration motion 81b in the longitudinal direction, which vibrates the both sides of the fixation portion 81f in the longitudinal direction illustrated in FIG. 8C, is not substantially changed.

Similarly, the long-side dimension L2 of the flat-plate portion 81c illustrated in FIG. 8A is changed. Then, the vibration frequency f2 of the vibration motion 81b in the longitudinal direction, which vibrates the both sides of the fixation portion 81f in the longitudinal direction illustrated in FIG. 8C, can be substantially changed.

Meanwhile, even if the long-side dimension L2 of the flat-plate portion 81c illustrated in FIG. 8A is changed, the vibration frequency f1 of the nodding motion 81a along the circumference centered at the fixation portion 81f of the flat-plate member 81 made of a rectangle illustrated in FIG. 8B is not substantially changed.

As illustrated in FIGS. 8A to 8C, the two vibration frequencies generated in the drive side plate 71 of the drive unit 7 are added to the flat-plate member 81 made of a rectangle through the support plate 73. The vibration frequency f1 of the nodding motion 81a along the circumference centered at the fixation portion 81f illustrated in FIG. 8B and the vibration frequency f2 of the vibration motion 81b in the longitudinal direction illustrated in FIG. 8C are set corresponding to the two vibration frequencies.

That is, the flat-plate portions 81c vibrating around the fixation portions 81f of the flat-plate members 81 made of a rectangle fixed to the support plates 73 illustrated in FIG. 3 through the fixation portions 81f is considered. The two resonant frequencies that induce primary mode vibration in the respective directions of two perpendicular axes of the flat-plate portion 81c are set to be matched with integral multiple components of rotational frequencies of the motors 72d, 72g, and 72i that serve as the drive sources. Alternatively, the two resonant frequencies are set to be matched with the frequencies of the vibration excitation generated when the gears that serve as the drive transmission portions illustrated in FIG. 4 are meshed with each other. The resonant frequencies are set to be matched with two frequency components appropriately selected from among the aforementioned frequency components.

The frequency components that substantially excites vibration are substantially changed according to the type of the motors 72d, 72g, and 72i that serve as the drive sources. For example, in a case of a drive system that is rotated at an extremely high speed like a polygon mirror provided in the laser scanner 29, one time of rotation (primary mode vibration) and two times of rotation (secondary mode vibration) of the motors become problem.

Meanwhile, in a case of a 6-phase 4-pole direct current (DC) brushless motor, 6×4=24th order mode vibration is mainly induced. As the integral multiple components of the respective rotational frequencies of the motors 72d, 72g, and 72i that serve as the drive sources, up to 50th order mode vibration may just be considered.

Here, the frequency of the vibration excitation is a frequency at which the teeth of the gears of the drive transmission system are meshed with each other. As a method of measuring the frequency of the vibration excitation, the rotational speeds of the motors are measured with a tachometer (rotational speed meter) or the like, and a frequency at which the teeth of the gears are meshed with each other can be calculated using a reduction ratio of the gears. As the drive transmission system, timing belts or the like, other than the gears, may be used.

The drive transmission portion illustrated in FIG. 4 includes the speed reducer where the gears are meshed with each other. Then, the frequencies are set to be matched with the vibration frequencies generated from the motors 72d, 72g, and 72i that serve the drive sources. Alternatively, the frequencies are set to be matched with the vibration frequencies generated from the speed reducers. Arbitrary two frequency components, of the aforementioned frequency components, are set to be matched with the resonant frequencies of the flat-plate member 81 made of a rectangle.

Accordingly, the flat-plate member 81 made of a rectangle that can decrease the two vibration frequency components at the same time with the lower-cost and more space-saving configuration than the comparative example illustrated in FIGS. 4, 5, and 20, and Japanese Patent Laid-Open No. 2010-032011 and Japanese Patent Laid-Open No. 2009-257463 can be realized.

In Japanese Patent Laid-Open No. 2009-257463, the fixation portions can absorb the two vibration frequencies at four places. Meanwhile, in the flat-plate member 81 made of a rectangle of the present embodiment, the fixation portion 81f is one place and thus the fixing region can be saved. Further, the flat-plate member 81 can absorb the vibration of the two vibration frequencies f1 and f2, and can be inevitably configured as a space-saving flat-plate member 81 suitable for the image forming apparatus 1.

### <Application to Image Forming Apparatus of Flat-Plate Member>

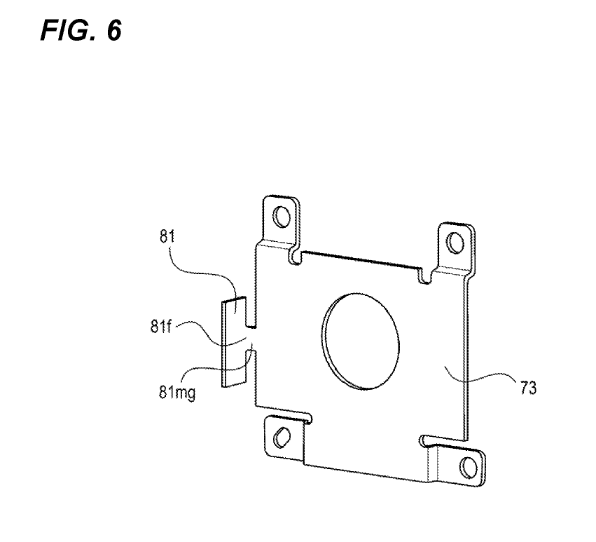

Next, an example of application of the flat-plate member 81 made of a rectangle illustrated in FIGS. 7 and 8 to the drive unit 7 of the image forming apparatus 1 will be described using FIGS. 3 and 6.

FIG. 3 is a perspective view of an appearance of the drive unit 7 to which the flat-plate members 81 made of a rectangle illustrated in FIGS. 7 and 8 of the first embodiment are applied. In FIG. 3, the motor 72i that rotates and drives the intermediate transfer belt 31, the developing device 28K of black K, and the photoconductor drum 30K of black K is provided on the drive unit 7.

Further, the motor 72g that rotates and drives the developing devices 28M, 28C, and 28Y of magenta M, cyan C, and yellow Y is provided. Further, the motor 72d that rotates and drives the photoconductor drum 30M, 30C, and 30Y of magenta M, cyan C, and yellow Y is provided.

The motors 72d, 72g, and 72i are attached to the support plates 73, and the support plates 73 are attached to the drive side plate 71.

In the present embodiment, the flat-plate members 81 made of a rectangle illustrated in FIGS. 7 and 8 are integrally molded with the same component as the support plates 73 on the support plates 73 of the motors 72d, 72g, and 72i illustrated in FIG. 6.

The flat-plate members 81 made of an end portion center fixed-type rectangle illustrate in FIGS. 7 and 8 are provided on the respective support plates 73 of the motors 72d, 72g, and 72i, as illustrated in FIG. 6. Meanwhile, periodic vibration of the motors 72d, 72g, and 72i is transmitted to the drive side plate 71 through the support plates 73.

Further, the mesh vibration between the pinion gears 72dp, 72gp, and 72ip fixed to the rotating shafts of the motors 72d, 72g, and 72i, and the initial gears 91d, 91g, 91dk, and 91gk that serve as the speed reducers is transmitted to the drive side plate 71 through the support plates 73.

Among the vibration frequencies, the two vibration frequencies f1 and f2 corresponding to the short-side dimension L1 and the long-side dimension L2 of the flat-plate portion 81c of the flat-plate member 81 made of a rectangle illustrated in FIGS. 7 and 8 can be absorbed by the flat-plate member 81 and can be decreased. Further, noises generated due to the vibration of the support plates 73 can be decreased.

For example, the motor 72g that rotates and drives the developing device 28M, 28C, and 28Y of magenta M, cyan C, and yellow Y is rotated. At that time, consider cases in which the frequencies of the mesh vibration between the pinion gear 72gp fixed to the rotating shaft 72g1 of the motor 72g, which has the most serious problem, and the large-diameter gear 91g1 of the initial gear 91g, are 240 Hz and 480 Hz.

The vibration frequency generated by the nodding motion 81a along the circumference centered at the fixation portion 81f illustrated in FIG. 8B of the flat-plate member 81 illustrated in FIG. 6 fixed to the support plate 73 of the motor 72g through the fixation portion 81f is set to 240 Hz. Further, the vibration frequency generated by the vibration motion 81b in the longitudinal direction illustrated in FIG. 8C is set to 480 Hz. Accordingly, the two vibration frequencies f1 and f2 can be absorbed by the one flat-plate member 81 and can be decreased.

In the present embodiment, the motor 72g that rotates and drives the developing devices 28M, 28C, and 28Y of magenta M, cyan C, and yellow Y has been described. Alternatively, the motor 72i rotates and drives the intermediate transfer belt 31, the developing device 28K of black K, and the photoconductor drum 30K of black K. The motor 72i, and the motor 72d that rotates and drives the photoconductor drums 30M, 30C, and 30Y of magenta M, cyan C, and yellow Y can also be similarly configured.

Further, the support plate 73 illustrated in FIG. 6 is an example in which only one flat-plate member 81 is fixed to a central portion of one side (a left end in FIG. 6) of the square support plate 73.

Alternatively, the flat-plate member 81 may be fixed to a right end in FIG. 6 of the support plate 73 illustrated in FIG. 6, or the flat-plate member 81 may be fixed to an upper or lower end in FIG. 6 of the support plate 73 illustrated in FIG. 6.

Alternatively, a plurality of the flat-plate members 81 maybe fixed to the sides of the support plate 73 that serves as the support member illustrated in FIG. 6, as needed. In the case where the plurality of flat-plate members 81 is mounted to the sides of the support plate 73 that serves as the support member illustrated in FIG. 6, the flat-plate members 81 respectively corresponding to different vibration frequencies can be obtained.

For example, in the case of the flat-plate member 81 fixed to the left end of the support plate 73 illustrated in FIG. 6, the vibration frequency generated by the nodding motion 81a along the circumference centered at the fixation portion 81f illustrated in FIG. 8B is set to 240 Hz. Further, the vibration frequency generated by the vibration motion 81b in the longitudinal direction illustrated in FIG. 8C is set to 480 Hz.

In the case of the flat-plate member 81 mounted to the right end of the support plate 73 illustrated in FIG. 6, the vibration frequency generated by the nodding motion 81a along the circumference centered at the fixation portion 81f illustrated in FIG. 8B is set to 720 Hz. Further, the vibration frequency generated by the vibration motion 81b in the longitudinal direction illustrated in FIG. 8C is set to 960 Hz.

Accordingly, the two vibration frequency components, of the vibration phenomena generated in the main system structure body of the drive side plate 71 that serves as the frame structure body, can be decreased at the same time by the flat-plate member 81 made of a rectangle configured from at least one component with a low-cost and space-saving configuration. As a result, the vibration radiation sounds generated from the drive side plate 71 can be decreased.

### Second Embodiment

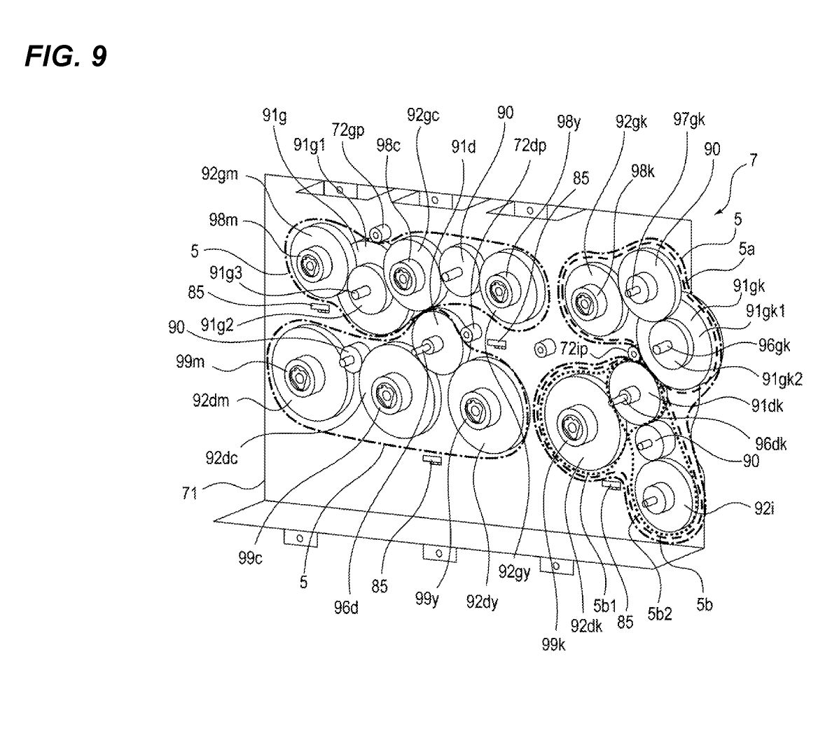

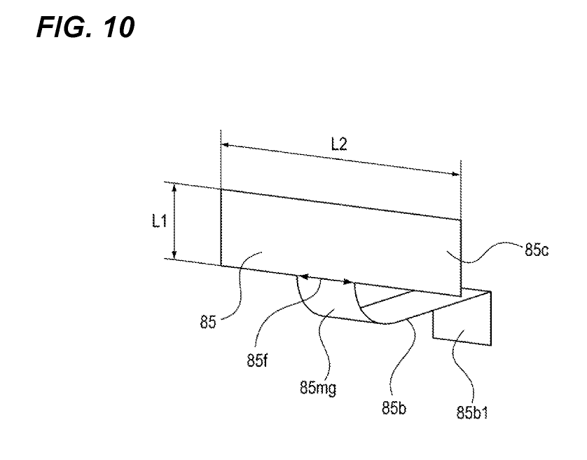

Next, a configuration of a second embodiment of an image forming apparatus including a drive transmission mechanism according to the present invention will be described using FIGS. 9 and 10. FIG. 10 is a perspective view of an appearance of a flat-plate member 85 made of a rectangle applied in the present embodiment. Note that those similarly configured from the first embodiment are given the same member names although the same or different reference numerals are denoted, and description is omitted.

In the present embodiment, as illustrate in FIGS. 9 and 10, a flat-plate member 85 made of an end portion center fixed-type rectangle fixed with one or more (one in the present embodiment) fixation portion 85f is provided to a drive side plate 71 of a drive unit 7.

As illustrated in FIG. 9, in the present embodiment, the flat-plate member 85 made of a rectangle is directly fixed to the drive side plate 71 that serves as a frame structure body that has a problem of vibration radiation sounds.

In the fixation portion 85f of the present embodiment, an area of a rectangular flat-plate portion 85c of the flat-plate member 85 made of a rectangle is set to be larger than an area of a fixing region of the fixation portion 85f fixed to the drive side plate 71 of the drive unit 7.

The flat-plate member 85 made of a rectangle of the present embodiment is configured from a damping steep sheet, and the fixation portion 85f is provided to a part (central portion) of a side (long side) around the flat-plate portion 85c.

As illustrated in FIG. 10, a bent portion 85mg of a ribbon-like arm portion 85b is integrally connected to the flat-plate portion 85c of the flat-plate member 85 made of a rectangle through the fixation portion 85f. As illustrated in FIG. 9, a fixation portion 85b1 provided in the other end portion of the arm portion 85b is fixed to the drive side plate 71 with a screw or the like that serves as a fixation portion.

In the present embodiment, as illustrated in FIG. 9, a plurality of the flat-plate members 85 made of an end portion center fixed-type rectangle is fixed to arbitrary positions of the drive side plate 71 of the drive unit 7.

In the present embodiment, as the position where the flat-plate member 85 made of an end portion center fixed-type rectangle, a center of vibration where a vibration frequency to be suppressed by the flat-plate member 85 is remarkably caused.

In the present embodiment, the flat-plate portion 85c vibrating around the fixation portion 85f of the flat-plate member 85 made of a rectangle is considered. Two resonant frequencies that induce primary mode vibration in the respective directions of two perpendicular axes of the flat-plate portion 85c are set to be matched with integral multiple components of a rotational frequency of a motor 72d, 72g, or 72i that serves as a drive source. Alternatively, the two resonant frequencies are set to be matched with frequencies of vibration excitation generated from a drive transmission portion made of gears illustrated in FIG. 9. The resonant frequencies are set to be matched with two frequency components appropriately selected from among the aforementioned frequency components.

The vibration frequencies absorbed by the plurality of flat-plate members 85 made of an end portion center fixed-rectangle fixed to the arbitrary positions of the drive side plate 71 of the drive unit 7 are as follows. Two frequencies are appropriately selected from order components of periodical vibration frequencies of the three motors 72d, 72g, and 72i provided on the drive side plate 71 of the drive unit 7 and frequencies of mesh vibration of arbitrary gears. Then, shapes of a short-side dimension L1, a long-side dimension L2, and the like of the flat-plate portion 85c of the flat-plate member 85 made of an end portion center fixed-type rectangle illustrated in FIG. 10 are appropriately set.

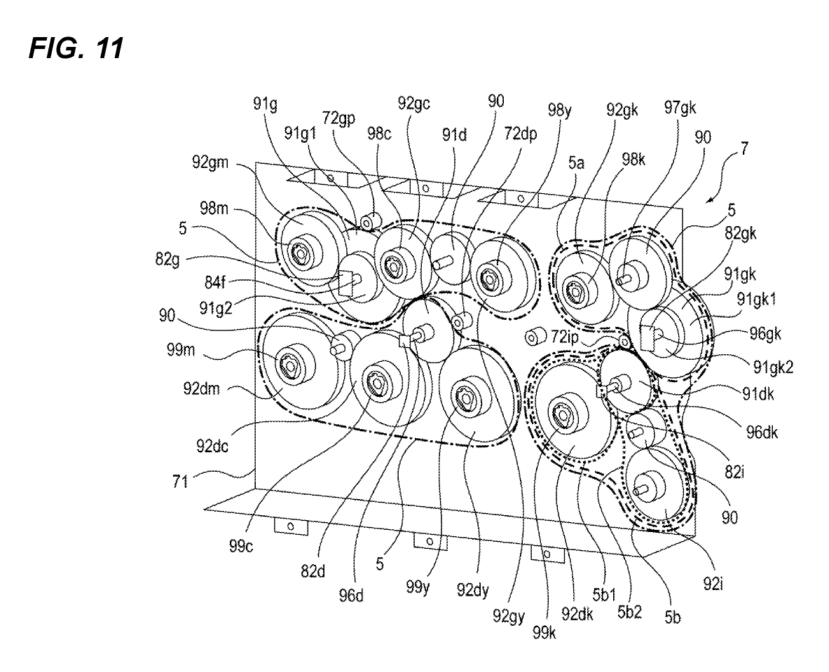

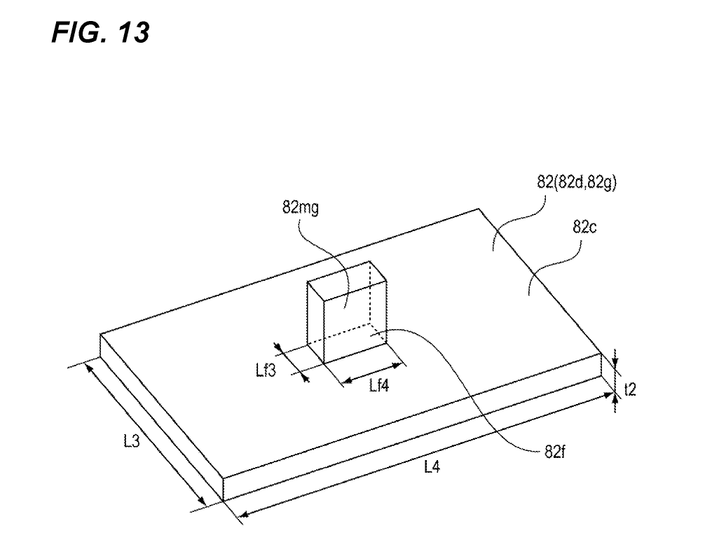

The present embodiment is an example in which the flat-plate member 85 made of an end portion center-fixed type rectangle is fixed to the drive side plate 71 of the drive unit 7. Further, like the first embodiment illustrated in FIG. 3, the flat-plate member 81 made of an end portion center fixed-type rectangle illustrated in FIG. 7 may be integrally provided to a support plate 73 that serves as a support member. Further, like a third embodiment illustrated in FIG. 11 described below, a configuration in which flat-plate members 82 made of a center fixed-type rectangle illustrate in FIG. 13 are attached to rotating shafts of gears that serve as drive transmission portions may be used together. Other configurations are similarly configured from those in the first embodiment and the third embodiment described below, and similar effects can be obtained.

### Third Embodiment

Next, a configuration of a third embodiment of an image forming apparatus including a drive transmission mechanism according to the present invention will be described using FIGS. 11 to 16. Note that those similarly configured from the above-described embodiments are given the same member names although the same or different reference numerals are denoted, and description is omitted.

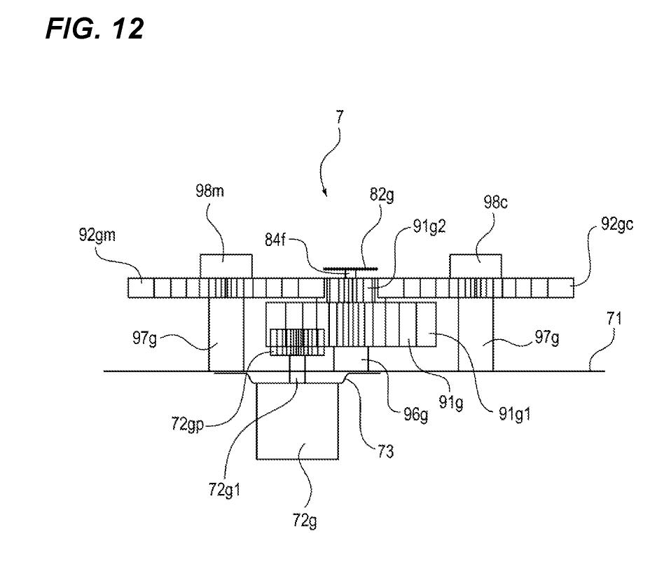

In the present embodiment, as illustrated in FIGS. 11 and 12, a flat-plate member 82 made of a center fixed-type rectangle illustrated in FIG. 13 is fixed as follows. The flat-plate members 82 are fixed to respective rotating shafts of initial gears 91d, 91dk, 91g, and 91gk, which serve as drive transmission portions provided in a drive unit 7 and serve as speed reducers.

Accordingly, vibration radiation sounds are suppressed, which are generated through vibration of a drive side plate 71 that serves as a frame structure body due to mesh vibration between the initial gears 91d, 91dk, 91g, and 91gk, and pinion gears 72dp, 72ip, and 72gp meshed therewith.

Shake of the drive side plate 71 by the rotating shafts of the gears is one cause of the mesh vibration of the gears. Therefore, in the present embodiment, attaching members 82mg of the flat-plate members 82 made of a center fixed-type rectangle illustrated in FIG. 13 are fixed to the respective rotating shafts of the initial gears 91d, 91dk, 91g, and 91gk.

In the present embodiment, the pinion gears 72dp, 72ip, and 72gp are fixed to rotating shafts of three motors 72d, 72g, and 72i provided on the drive side plate 71 of the drive unit 7. The attaching members 82mg of flat-plate members 82d, 82g, 82i, and 82gk are fixed to the rotating shafts of the initial gears 91d, 91g, 91dk, and 91gk to which rotational driving force is transmitted from the pinion gears 72dp, 72ip, and 72gp. The flat-plate members 82d, 82g, 82i, and 82gk illustrated in FIG. 13 include a plate-like flat-plate portion 82c made of a center fixed-type rectangle.

FIG. 12 is an explanatory plan view of a vicinity of the motor 72g as viewed from above, which rotates and drives developing devices 28M, 28C, and 28Y of magenta M, cyan C, and yellow Y. As illustrated in FIG. 12, a rotating shaft 91g3 of the initial gear 91g made of a two-stage gear in which a large-diameter gear 91g1 is meshed with the pinion gear 72gp fixed to a rotating shaft 72g1 of the motor 72g is rotatably supported by a support shaft 96g provided on the drive side plate 71. A fixation portion 84f that fixes the flat-plate member 82g made of a center fixed-type rectangle illustrated in FIG. 13 is provided on a tip portion of the rotating shaft 91g3 of the initial gear 91g.

The attaching member 82mg of the flat-plate member 82g made of a center fixed-type rectangle illustrated in FIG. 13 is mounted on the fixation portion 84f provided to the tip portion of the rotating shaft 91g3 of the initial gear 91g. At that time, the position of the center of gravity of the flat-plate member 82g made of a center fixed-type rectangle illustrated in FIG. 13 is matched with the center of figure (the position of the center of gravity) of the fixation portion 84f.

As illustrated in FIGS. 11 and 12, the attaching member 82mg of the flat-plate member 82g made of a center fixed-type rectangle illustrated in FIG. 13 is fixed to the fixation portion 84f provided to the tip portion of the rotating shaft 91g3 of the initial gear 91g. Accordingly, the two vibration frequencies excited by the initial gear 91g to the drive side plate 71 can be decreased.

Further, as illustrated in FIG. 11, the flat-plate members 82d, 82g, 82i, 82gk made of a rectangle are mounted and fixed to the tip portions of the rotating shafts of the initial gears 91d, 91g, 91dk, and 91gk that serve as the speed reducers. The flat-plate members 82d, 82g, 82i, and 82gk made of a rectangle are as follows. Shapes correspond to order components of mesh frequencies between the initial gears 91d, 91g, 91dk, and 91gk to which the flat-plate members are attached, and lower gears 92dc, 92dy, 92gc, 92gm, 92dk, and an idler gear 90.

For example, assume that a basic component of the mesh frequency between a small-diameter gear 91g2 of the initial gear 91g made of a two-stage gear that rotates and drives the developing devices 28M, 28C, and 28Y of magenta M, cyan C, and yellow Y, and the lower gears 92gc and 92gm is 300 Hz.

Further, a case in which the basic component of the mesh frequency between the initial gear 91d that rotates and drives the photoconductor drums 30M, 30C, and 30Y of magenta M, cyan C, and yellow Y, and the lower gears 92dc and 92dy is 400 Hz will be described.

As for the frequency of the mesh vibration between the gears, for example, the rotating shaft 91g3 of the initial gear 91g is rotatably supported by the support shaft 96g provided on the drive side plate 71. The flat-plate member 82g made of a center fixed-type rectangle illustrated in FIG. 13 fixed to the fixation portion 84f of the initial gear 91g is as follows. The vibration at 300 Hz and 600 Hz that are two frequencies corresponding to the appropriately set short-side dimension L3 and long-side dimension L4 is absorbed by the flat-plate member 82g and decreased.

Meanwhile, the rotating shaft of the initial gear 91d is rotatably supported by the support shaft 96d provided to the drive side plate 71. The flat-plate member 82d made of a center fixed-type rectangle illustrated in FIG. 13 fixed to the fixation portion 84f of the initial gear 91d is as follows. The vibration at 400 Hz and 800 Hz that are two frequencies corresponding to the appropriately set short-side dimension L3 and long-side dimension L4 are absorbed by the flat-plate member 82d and decreased.

With the configuration, the drive unit 7 that can decrease the radiation vibration sounds of the drive side plate 71 as the frame structure body, for the different vibration frequencies provided to the drive side plate 71 by the mesh vibration between the gears.

### <Flat-Plate Member Made of Center Fixed-Type Rectangle>

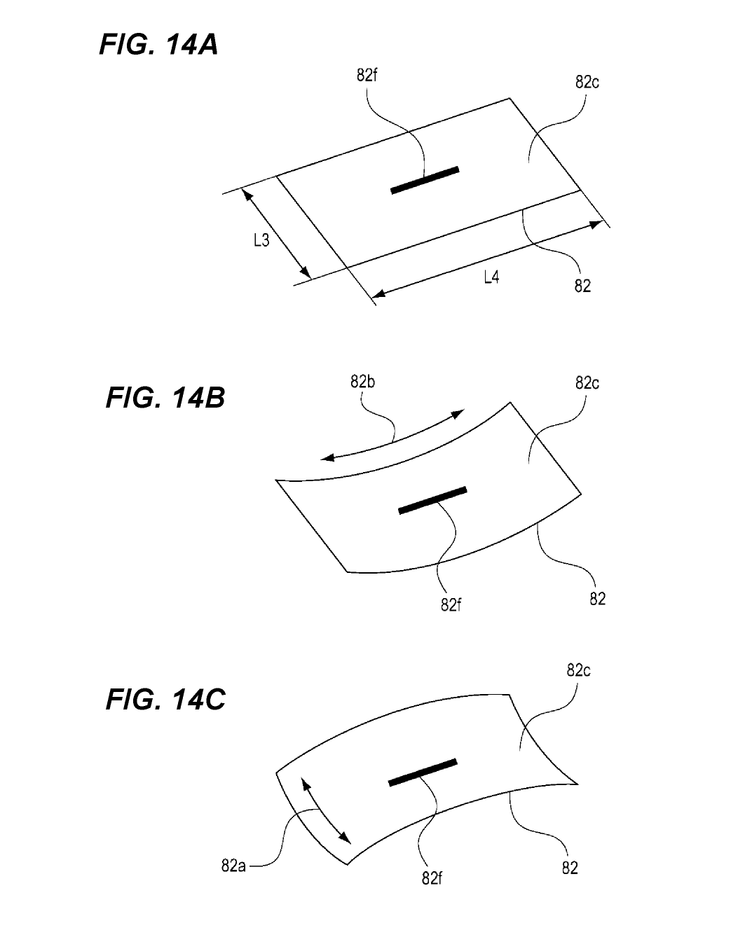

Next, a configuration of the flat-plate member 82 made of a center fixed-type rectangle applied to an image forming apparatus 1 of the present embodiment will be described using FIGS. 13 and 14.

As illustrated in FIG. 13, the flat-plate member 82 made of a center fixed-type rectangle applied to the image forming apparatus 1 of the present embodiment is configured from a rectangle in which the flat-plate portion 82c has a short-side dimension L3 and a long-side dimension L4. The flat-plate member 82 of the present embodiment is configured from a damping steel sheet.

Further, a fixation portion 82f is provided in a central portion of the flat-plate portion 82c of the flat-plate member 82 made of a center fixed-type rectangle illustrated in FIG. 13, and the attaching member 82mg is provided through the fixation portion 82f.

The fixation portion 82f illustrated in FIG. 13 is configured from a rectangle having a short-side dimension Lf3 and a long-side dimension Lf4. As a characteristic of the fixation portion 82f of the present embodiment, the fixation portion 82f is set to satisfy the relationship of the numerical formula 1 below using the short-side dimension L3 and the long-side dimension L4 of the flat-plate member 82 made of a rectangle and the short-side dimension Lf3 and the long-side dimension Lf4 of the fixation portion 82f.

L3×L4>Lf3×Lf4 [Numerical Formula 1]

Note that {L3×L4} described on the left side of the numerical formula 1 corresponds to an area of the flat-plate portion 82c of the flat-plate member 82 illustrated in FIG. 13. Further, {Lf3×Lf4} described on the right side of the numerical formula 1 corresponds to an area of the fixation portion 82f of the flat-plate member 82 illustrated in FIG. 13.

In the present embodiment, as illustrated in FIGS. 11 and 12, the fixation portions 82f of the flat-plate members 82 illustrated in FIG. 13 are provided and fixed to the rotating shafts of the initial gears 91d, 9ldk, 91g, an 91gk, which are configured as the drive transmission portions and as the speed reducers.

Then, the area (=L3×L4) of the flat-plate portion 82c is set to be larger than the area (=Lf3×Lf4) of the fixing region where the fixation portion 82f is fixed to the rotating shaft of the initial gear 91d, 91dk, 91g, or 91gk that serves as the drive transmission portion, by the numerical formula 1.

The long-side dimension L4 of the flat-plate member 82 made of a rectangle illustrated in FIG. 14A is appropriately set. Accordingly, a vibration frequency of vibration motion 82b in a longitudinal direction of the flat-plate member 82 made of a rectangle illustrated in FIG. 14B can be controlled.

Further, the short-side dimension L3 of the flat-plate member 82 made of a rectangle illustrated in FIG. 14A is appropriately set. Accordingly, a vibration frequency of vibration motion 82a in a short direction of the flat-plate member 82 made of a rectangle illustrated in FIG. 14C can be controlled. In the present embodiment, the short-side dimension L3 and the long-side dimension L4 of the flat-plate portion 82c of the flat-plate member 82 desirably satisfy {L3<L4}, as described above.

Therefore, the flat-plate portion 82c vibrating around the fixation portion 82f of the flat-plate member 82 made of a center fixed-type rectangle of the present embodiment illustrated in FIG. 13 is considered. Two resonant frequencies that induce primary mode vibration in the respective directions of two perpendicular axes of the flat-plate portion 82c are as follows. The two resonant frequencies are matched with frequencies of vibration excitation generated by mesh vibration between the initial gears 91d, 91dk, 91g, and 91gk that serve as the drive transmission portions and the pinion gears 72dp, 72ip, and 72gp meshed with the initial gears. Further, the two resonant frequencies are matched with integral multiple components of rotational frequencies of the motors 72d, 72g, and 72i that serve as the drive sources. The flat-plate member 82 can be configured such that the two resonant frequencies are matched with two frequency components selected from among the frequency components.

Further, the initial gears 91d, 91dk, 91g, and 91gk that serve as the speed reducers and the pinion gears 72dp, 72ip, and 72gp meshed therewith are meshed with one another. The two resonant frequencies of the flat-plate member 82 made of rectangle can be set to frequencies corresponding to order components of the mesh frequencies.

FIG. 11 illustrates an example in which the plurality of flat-plate members 82 illustrated in FIG. 13 is provided to the respective rotating shafts of the initial gears 91d, 91dk, 91g, and 91gk that serve as the speed reducers.

Specific dimension design of the flat-plate member 82 made of a center fixed-type rectangle illustrated in FIG. 13 can be appropriately set based on a result of a vibration mode analysis of the flat-plate member 82 made of a center fixed-type rectangle using a finite element method.

The case of the flat-plate member 81 made of an end portion center fixed-type rectangle illustrated in FIG. 7 described in the first embodiment is as follows. The short-side dimension L1 and the long-side dimension L2 of the flat-plate portion 81c, the length (in the longitudinal direction of the fixation portion 81f) Lf2 of the line segment 6 that connects the two fixed end portions 81mp, and a plate thickness t1 of the flat-plate portion 81c are appropriately set.

Further, in the case of the flat-plate member 82 made of a center fixed-type rectangle illustrated in FIG. 13 of the present embodiment, the short-side dimension L3 and the long-side dimension L4 of the flat-plate portion 82c of the flat-plate member 82, and the short-side dimension Lf3 and the long-side dimension Lf4 of the fixation portion 82f are appropriately set.

In the case of the flat-plate member 82 made of a center fixed-type rectangle illustrated in FIG. 13, the fixation portion 82f is provided in the central portion of the flat-plate portion 82c of the flat-plate member 82. Alternatively, a center position of the flat-plate portion 82c of the flat-plate member 82 made of a rectangle illustrated in FIG. 13 and the position of the fixation portion 82f may be shifted.

### <Damping Effect>

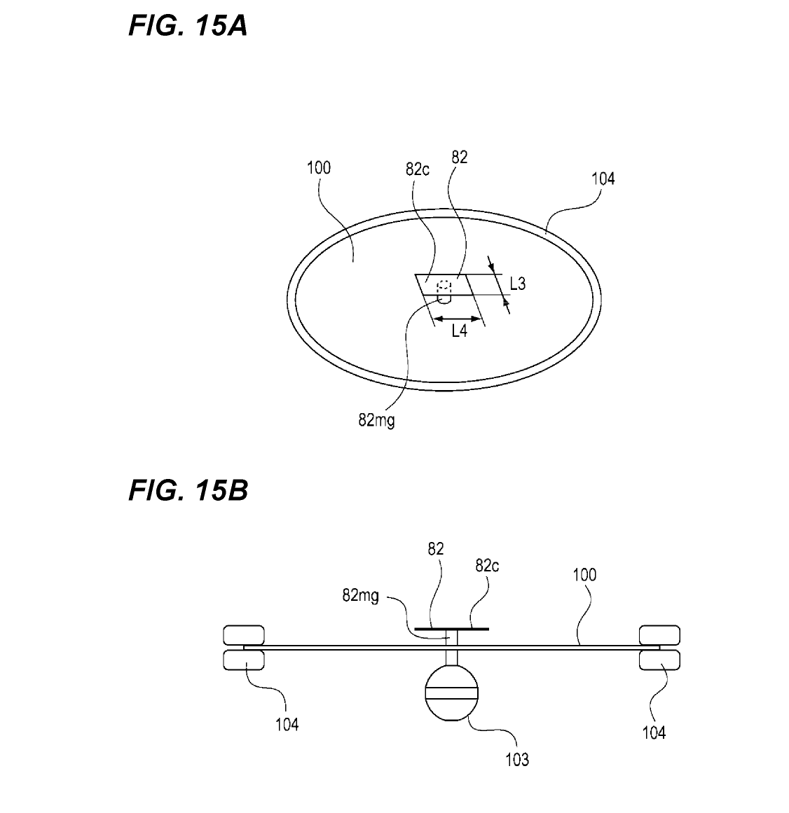

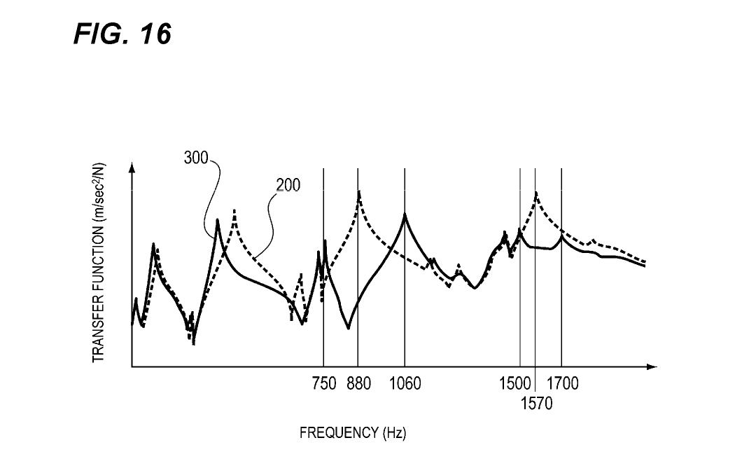

Next, a result of an experiment that confirms a damping effect of the flat-plate member 82 made of a center fixed-type rectangle illustrated in FIGS. 13 and 14 will be described using FIGS. 15 and 16.

As illustrated in FIG. 15A, the attaching member 82mg of the flat-plate member 82 made of a rectangle illustrated in FIG. 13 is attached to a central upper surface of a disk-like panel 100. Then, an exciter 103 illustrated in FIG. 15B is glued with a glue to a lower surface of the panel 100 immediately below the attaching member 82mg. A peripheral edge of the panel 100 is fixed with the fixation portion 104.

The panel 100 illustrated in FIG. 15 used in the damping experiment has a diameter of 29 cm, the long-side dimension L4 of the flat-plate portion 82c of the flat-plate member 82 of 8 cm, and the short-side dimension L3 of 6 cm.

A vibration frequency characteristic 200 of the panel 100 at the time of not mounting the flat-plate member 82 made of a rectangle illustrated in FIG. 15 is illustrated by the dotted line of FIG. 16. The horizontal axis of FIG. 16 represents a frequency of vibration, and the vertical axis represents a transfer function of the vibration. As illustrated in FIG. 16, the panel 100 has large resonant peaks at 880 Hz and 1570 Hz of the frequencies of the vibration.

In the present embodiment, as illustrated in FIGS. 15A and 15B, the flat-plate member 82 made of a rectangle is attached to the central portion of the panel 100. Accordingly, whether the resonant peaks at 880 Hz and 1570 Hz of the frequencies of the vibration of the panel 100 can be decreased is confirmed.

A vibration frequency characteristic 300 of a panel 100 of when the flat-plate member 82 made of a rectangle set to have optimum dimensions corresponding to the panel 100 that is vibrated by the exciter 103 illustrated in FIG. 15B is mounted on the panel 100 is illustrated by the solid line of FIG. 16.

It has been confirmed that the resonant peaks at 880 Hz and 1570 Hz of the frequencies of the vibration of the panel 100 can be decreased by the flat-plate member 82 made of a rectangle illustrated in FIGS. 15A and 15B.

Further, as illustrated in FIG. 16, it has been confirmed that the resonant peaks are generated at larger and smaller resonant frequencies of 880 Hz and 1570 Hz where the resonant peaks are decreased. To be specific, the resonant peak at 880 Hz of the frequency of the vibration of the panel 100 is divided into 750 Hz and 1060 Hz. This is found a damping effect by the flat-plate member 82 made of a rectangle.

Further, a microphone is installed on an upper portion of the panel 100 and a sound pressure data value is measured at the same time. It has been confirmed that the sound pressure data value measured by the microphone becomes small by mounting the flat-plate member 82 made of a rectangle illustrated in FIGS. 15A and 15B on the panel 100 at 880 Hz and 1570 Hz of the frequencies of the vibration of the panel 100.

Both of the vibration of the central portion of the panel 100 and the sound pressure data value measured by the microphone can be made small by the flat-plate member 82 made of a rectangle.

The long-side dimension L4 is 8 cm and the short-side dimension L3 is 6 cm in the flat-plate portion 82c of the flat-plate member 82 made of a rectangle of the present embodiment illustrated in FIG. 15A. Alternatively, the size of the flat-plate member 82 can be made short by appropriately changing material characteristics of the flat-plate member 82, the shape of the fixation portion 82f, and setting conditions of a plate thickness t2 of the flat-plate portion 82c and the like.

The present embodiment has a configuration in which the flat-plate members 82 made of a center fixed-type rectangle illustrated in FIG. 13 are attached to the rotating shafts of the gears. Alternatively, a configuration in which the flat-plate members 81 made of an end portion center fixed-type rectangle are attached to the rotating shafts of the gears illustrated in FIG. 7 may be employed. Other configurations are similarly configured from the above-described embodiments, and similar effect can be obtained.

### Fourth Embodiment

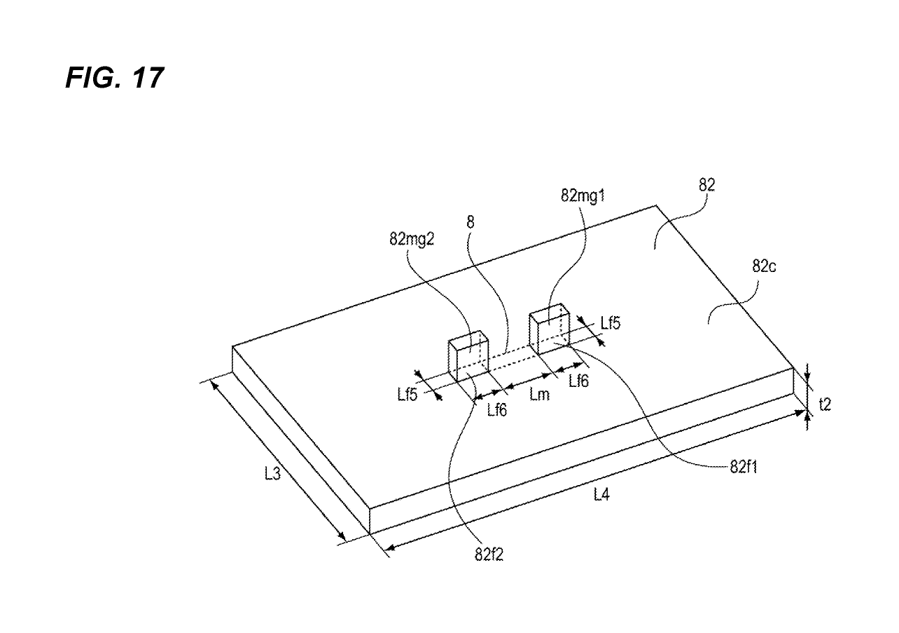

Next, a configuration of a fourth embodiment of an image forming apparatus including a drive transmission mechanism according to the present invention will be described using FIG. 17. Note that those similarly configured from the above-described embodiments are given the same member names although the same or different reference numerals are denoted, and description is omitted.

In the present embodiment, as illustrated in FIG. 17, two (a plurality of) fixation portions 82f1 and 82f2 are provided on a central portion of a flat-plate portion 82c of a flat-plate member 82 made of a rectangle. In the present embodiment, two attaching members 82mg1 and 82mg2 are provided on the flat-plate portion 82c of the flat-plate member 82 made of a rectangle through the fixation portions 82f1 and 82f2.

An important point at that time is as follows. Short-side dimensions of the fixation portions 82f1 and 82f2 are Lf5, long-side dimensions are Lf6, and a separate distance between the two fixation portions 82f1 and 82f2 is Lm.

A short-side dimension L3 and a long-side dimension L4 of the flat-plate member 82 made of a center fixed-type rectangle illustrated in FIG. 17 are used. The short-side dimension Lf5 and the long-side dimension Lf6 of the fixation portions 82f1 and 82f2, and the separate distance Lm between the two fixation portions 82f1 and 82f2 are set to satisfy the relationship of the numerical formula 2.

L3×L4>Lf5×(2×Lf6+Lm) [Numerical Formula 2]

Note that {L3×L4} described on the left side of the numerical formula 2 corresponds to an area of the flat-plate portion 82c of the flat-plate member 82 illustrated in FIG. 17. Further, {Lf5×(2×Lf6+Lm)} described on the right side of the numerical formula 2 corresponds to a total area surrounded by a square line segment 8 connecting an outer periphery of the two fixation portions 82f1 and 82f2 of the flat-plate member 82 illustrated in FIG. 17.

According to the numerical formula 2, the total area surrounded by the square line segment 8 connecting the outer periphery of the two fixation portions 82f1 and 82f2 of the flat-plate member 82 illustrated in FIG. 17 is set to be smaller than the area of the flat-plate portion 82c of the flat-plate member 82 made of a center fixed-type rectangle illustrated in FIG. 17.

That is, the area (=L3×L4) of the flat-plate portion 82c of the flat-plate member 82 illustrated in FIG. 17 is as follows. The area (=L3×L4) is set to be larger than the area (=Lf5×(2×Lf6+Lm)) of a fixing region where the two fixation portions 82f1 and 82f2 of the flat-plate member 82 are fixed to drive transmission portions made of gears and the drive unit 7.

Further, generation of a biaxial vibration mode made of the two fixation portions 82f1 and 82f2 of the flat-plate member 82 illustrated in FIG. 17 is not limited. Therefore, the long-side dimension L4 of the flat-plate member 82 is set longer than (2×Lf6+Lm) that is the long-side dimension of the square line segment 8 connecting the outer periphery of the two fixation portions 82f1 and 82f2.

In the present embodiment, the flat-plate portion 82c vibrating around the two fixation portions 82f1 and 82f2 of the flat-plate member 82 is considered. The two resonant frequencies that induce primary mode vibration in the respective directions of two perpendicular axes of the flat-plate portion 82c are set to be matched with integral multiple components of rotational frequencies of motors 72d, 72g, and 72i that serve as drive sources. Alternatively, the two resonant frequencies are set to be matched with frequencies of vibration excitation generated by mesh vibration between the initial gears 91d, 91dk, 91g, and 91gk that serve as the drive transmission portions and as the speed reducers, and the pinion gears 72dp, 72ip, and 72gp meshed therewith. The flat-plate member 82 can be configured to have the two resonant frequencies matched with two frequency components selected from the aforementioned frequency components.

Further, an example in which the two attaching members 82mg1 and 82mg2 are provided to the flat-plate member 82 illustrated in FIG. 17 has been described. However, three or more attaching members may be provided. Other configurations are similarly configured from the above-described embodiments, and similar effect can be obtained.

### Fifth Embodiment

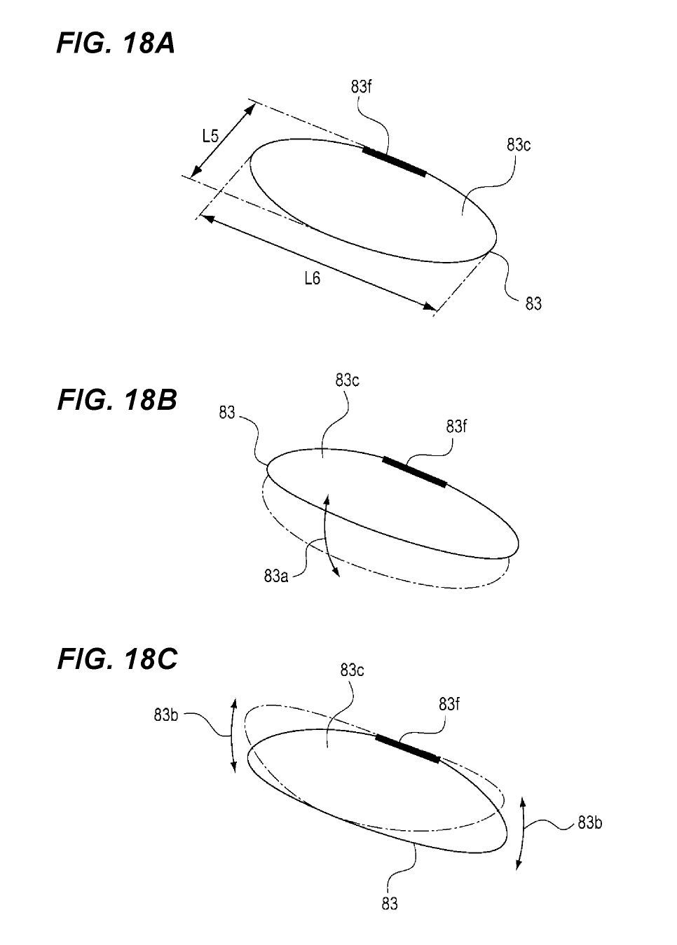

Next, a configuration of a fifth embodiment of an image forming apparatus including a drive transmission mechanism according to the present invention will be described with reference to FIG. 18. Note that those similarly configured from the above-described embodiments are given the same member names although the same or different reference numerals are denoted, and description is omitted.

Note that, in the above-described embodiments, the shapes of the flat-plate portions 81c, 82c, and 85c of the flat-plate members 81, 82, and 85 are configured from the rectangles. In the present embodiment, as illustrated in FIGS. 18A to 18C, a flat-plate member 83 made of an ellipse having a long axis and a short axis is included. With respect to speed reducers 5 (drive transmission portions) that transmit rotational driving force from motors 72d, 72g, and 72i (drive sources) to rotating members such as developing devices 28, photoconductor drums 30, and an intermediate transfer belt 31, or a drive unit 7, the flat-plate member 83 is as follows. A drive transmission mechanism in an image forming apparatus 1 in which a central portion of a long arc of the ellipse is fixed with one or more fixation portions 83f without fixing an end portion of the long axis of the ellipse is configured.

An area of a flat-plate portion 83c of the flat-plate member 83 is set to be larger than an area of a fixing area of the fixation portion 83f illustrated in FIGS. 18A to 18C, the area being fixed to the speed reducer 5 (drive transmission portion) or the drive unit 7. Then, two resonant frequencies that induce primary mode variation in respective directions of perpendicular two axes made of the long axis and the short axis of the elliptical flat-plate portion 83c vibrating around the fixation portion 83f are set as follows. The two resonant frequencies are set to be matched with to frequency components selected from integral multiple components of rotational frequencies of the motors 72d, 72g, and 72i (drive sources) and frequencies of vibration excitation generated from the speed reducers 5 (drive transmission portions).

In the present embodiment, the flat-plate member 83 can be configured from a damping steel sheet. The motor 72d that rotates and drives the photoconductor drums 30M, 30C, and 30Y of magenta M, cyan C, and yellow Y is configured as the drive source. The motor 72g that rotates and drives the developing devices 28M, 28C, and 28Y of magenta M, cyan C, and yellow Y is configured as the drive source. Further, the motor 72i that rotates and drives the intermediate transfer belt 31, the photoconductor drum 30K of black K, and the developing device 28K of black K is configured as the drive source. Then, the flat-plate members 83 can be provided to support plates 73 that serve as support members that respectively support these drive sources.

Further, a plurality of the flat-plate members 83 can be provided to the support plate 73. Further, the support plate 73 and the flat-plate members 83 can be integrally configured from the same member.

Further, the drive transmission portion includes the speed reducer 5 in which the gears are meshed with each other, and arbitrary two frequency components, of vibration frequencies generated from the drive sources and vibration frequencies generated from the speed reducers 5, can be matched with the resonant frequencies of the flat-plate members 83.

Further, the flat-plate member 83 is provided to a rotating shaft of the gears of the speed reducer 5, and the two resonant frequencies of the flat-plate member 83 can be set to frequencies corresponding to order components of a meshing frequency of the gears of the speed reducer 5.

Further, a plurality of the flat-plate members 83 can be provided to the rotating shafts of the gears of the speed reducer 5. Further, the flat-plate member 83 can be configured to have the resonant frequencies that are matched with any two of the integral multiple components of rotational frequencies of the drive sources, the frequencies of vibration excitation generated from the drive transmission portions, and own resonant frequencies of the drive transmission mechanism.

Further, the plurality of flat-plate members 83 can be provided to at least one of the drive sources, the drive transmission portions, and the drive transmission mechanism.

As illustrated in FIG. 18A, a short-side dimension L5 of the flat-plate portion 83c of the flat-plate member 83 and a long-side dimension L6 of the flat-plate portion 83c of the flat-plate member 83 are set to satisfy {L5<L6}. Further, FIG. 18B illustrates nodding motion 83a of the flat-plate portion 83c of the flat-plate member 83 in a short direction, and FIG. 18C illustrates vibration motion 83b of the flat-plate portion 83c of the flat-plate member 83 in a longitudinal direction. Other configurations are similarly configured from the above-described embodiments, and similar effect can be obtained.

### Sixth Embodiment

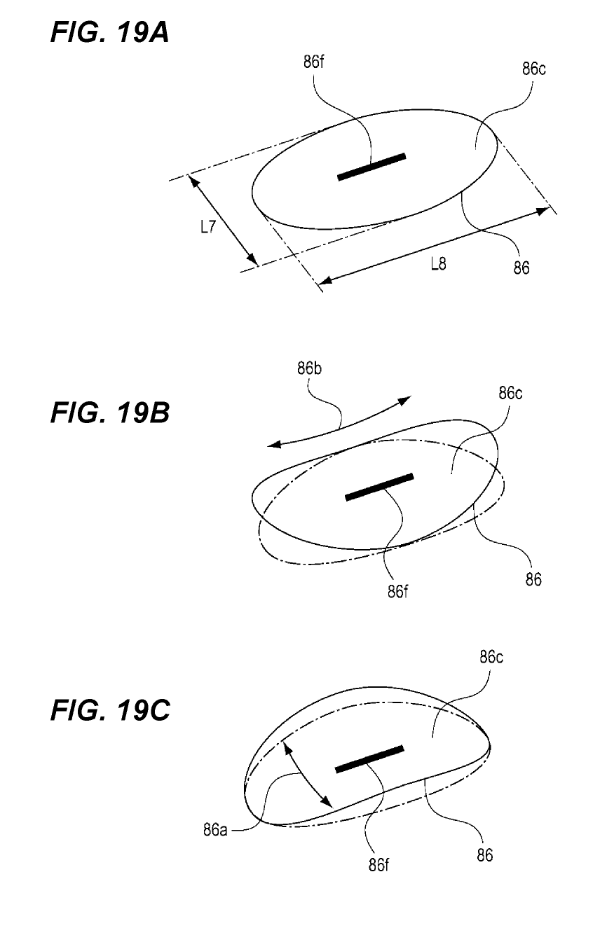

Next, a configuration of a sixth embodiment of an image forming apparatus including a drive transmission mechanism according to the present invention will be described using FIG. 19. Note that those similarly configured from the above-described embodiments are given the same member names although the same or different reference numerals are denoted, and description is omitted.

As illustrated in FIGS. 18A to 18C, in the fifth embodiment, the flat-plate member 83 including the elliptical flat-plate portion 83c is fixed to the speed reducer 5 (drive transmission portion) or the drive unit 7, as follows. The central portion of the long arc of the ellipse is fixed with one fixation portion 83f without fixing the end portion of the long axis of the ellipse.

In the present embodiment, as illustrated in FIGS. 19A to 19C, a flat-plate member 86 having an elliptical flat-plate portion 86c is fixed to a speed reducer 5 (drive transmission portion) or a drive unit 7, as follows. A central portion of the ellipse is fixed with one fixation portion 86f without fixing an end portion of a long axis of the ellipse.

Note that, in FIGS. 19A to 19C, the flat-plate member 86 including the elliptical flat-plate portion 86c is fixed to the speed reducer 5 (drive transmission portion) or the drive unit 7, as follows. FIGS. 19A to 19C illustrate an example in which the central portion of the long arc of the ellipse is fixed with one fixation portion 86f without fixing the end portion of the long axis of the ellipse. Alternatively, as illustrated in FIG. 17, the central portion of the long arc of the ellipse may be fixed with a plurality of the fixation portions.

As illustrated in FIG. 19A, a short-side dimension L7 of the flat-plate portion 86c of the flat-plate member 86 and a long-side dimension L8 of the flat-plate portion 86c of the flat-plate member 86 are set to satisfy {L7<L8}. Further, FIG. 19B illustrates vibration motion 83b of the flat-plate portion 86c of the flat-plate member 86 in a longitudinal direction, and FIG. 19C illustrates nodding motion 86a of the flat-plate portion 86c of the flat-plate member 86 in a short direction. Other configurations are similarly configured from the above-described embodiments, and similar effect can be obtained.

Note that the shapes of flat-plate portions 81c, 82c, 83c, 85c, and 86c of the flat-plate members 81, 82, 83, 85, and 86 can be configured from various shapes such as a rhomboid having a long axis (a dimension in the longitudinal direction) and a short axis (a dimension in the short direction) that have different lengths, or an oval, other than the rectangles or the ellipses.

Further, the plurality of flat-plate members 81, 82, 83, 85, and 86 of the embodiments can be appropriately provided to at least one of the motors 72d, 72g, and 72i that serve as the drive sources, the gears that serve as the drive transmission portions, and the body frame 9 (drive transmission mechanism) of the image forming apparatus 1.

Further, the flat-plate members 81, 82, 83, 85, and 86 of the embodiments have the resonant frequencies that are matched with the integral multiple components of the rotational frequencies of the motors 72d, 72g, and 72i that serve as the drive sources. Further, the flat-plate members 81, 82, 83, 85, and 86 have the resonant frequencies that are matched with the frequencies of the vibration excitation generated by the mesh vibrations between the initial gears 91d, 91dk, 91g, and 91gk that serve as the drive transmission portions and as the speed reducers, and the pinion gears 72dp, 72ip, and 72gp meshed therewith. Further, the flat-plate members 81, 82, 83, 85, and 86 have the resonant frequencies that are matched with the resonant frequencies of the body frame 9 (drive transmission mechanism itself) of the image forming apparatus 1. The flat-plate members 81, 82, 83, 85, and 86 can be set to have the resonant frequencies that are matched with any two of the aforementioned frequency components.

While the present invention has been described with reference to exemplary embodiments, it is to be understood that the invention is not limited to the disclosed exemplary embodiments. The scope of the following claims is to be accorded the broadest interpretation so as to encompass all such modifications, equivalent structures and functions.

This application claims the benefit of Japanese Patent Application No. 2015-125239, filed Jun. 23, 2015 which is hereby incorporated by reference herein in its entirety.

What is claimed is:

1. A drive transmission mechanism comprising:
a drive source;
a drive transmission portion including a drive transmission member that transmits driving force caused in the drive source;
a support plate which supports at least apart of the drive transmission portion;
a flat plate; and
a fixation portion having one end joined with the flat plate and the other end fixed to the support plate, wherein
a length in a longitudinal direction and a length in a short direction are set such that a first vibration frequency vibrating in the longitudinal direction of the flat plate and a second vibration frequency vibrating in the short direction of the flat plate respectively resonate with mutually different vibration frequencies caused in the support plate around a portion where the fixation portion and the flat plate are joined.

2. The drive transmission mechanism according to claim 1, wherein
the flat plate is a rectangle having a side having a length in the longitudinal direction and a side having a length in the short direction, or an ellipse having an axis having a length in the longitudinal direction and an axis having a length in the short direction.

3. The drive transmission mechanism according to claim 1, wherein
the flat plate is configured from a damping steel sheet.

4. The drive transmission mechanism according to claim 1, wherein
a plurality of the flat plates is provided to the support plate.

5. The drive transmission mechanism according to claim 1, wherein
a material of the support plate and a material of the flat plate are same.

6. The drive transmission mechanism according to claim 1, wherein
the drive transmission portion includes a speed reducer in which gears are meshed with each other, and the length in the longitudinal direction and the length in the short direction are set such that arbitrary two frequency components of vibration frequencies generated from the drive transmission portion are approximately matched with the vibration frequencies of the flat plate.

7. The drive transmission mechanism according to claim 6, wherein
the flat plate is provided to a rotating shaft of the gear of the speed reducer, and two resonant frequencies of the flat plate are set to frequencies corresponding to order components of a frequency at which the gears of the speed reducer are meshed with each other.

8. The drive transmission mechanism according to claim 6, wherein
a plurality of the flat plates is provided to the rotating shafts of the gears of the speed reducer.

9. The drive transmission mechanism according to claim 1, wherein
the first vibration frequency and the second vibration frequency of the flat plate are matched with any of integral multiple components of a rotational frequency of the drive source, a frequency of vibration excitation generated from the drive transmission portion, or an own resonant frequency of the drive transmission mechanism.

10. The drive transmission mechanism according to claim 1, wherein
the fixation portion is joined with the flat plate at an end portion of the flat plate.

11. The drive transmission mechanism according to claim 1, wherein
the fixation portion is joined with the flat plate at a plan portion of the flat plate.

12. An image forming apparatus comprising:
the drive transmission mechanism according to claim 1, wherein
the image forming apparatus is configured to form an image on a recording material.
